(19) United States
(12) Patent Application Publication
(10) Pub. No.: US 2026/0203145 A1
(43) Pub. Date: Jul. 16, 2026

(54) MPI COLLECTIVE OPERATIONS

(71) Applicant: UCL Business Ltd., London (GB)

(72) Inventors: Alessandro Ottino, London (GB); Georgios Zervas, London (GB); Joshua Benjamin, London (GB)

(21) Appl. No.: 19/132,289

(22) PCT Filed: Nov. 22, 2023
(86) PCT No.: PCT/GB2023/053050

§ 371 Date: May 22, 2025

(30) Foreign Application Priority Data
Nov. 24, 2022 (GB) 2217578.0

(51) Int. Cl. G06F 9/54

(52) U.S. Cl. CPC G06F 9/546

(57) ABSTRACT

A method for performing a message passing interface (MPI) collective operation in a network, wherein the network comprises a plurality of interconnected nodes, the method comprising: receiving, at a node of the plurality of interconnected nodes, MPI collective operation information identifying the MPI collective operation to be performed, and a graph of the network; determining a number of algorithmic steps of the MPI collective operation based on the MPI collective operation and the graph of the network; determining an initialisation process for the algorithmic steps; determining a finalisation process for the algorithmic steps; determining, for each of the algorithmic steps: a subset of nodes of the plurality of interconnected nodes for the node to communicate with; one or more portions of data for the node to send to and receive from the nodes within the subset of nodes; and initialising the MPI collective operation based on the determined subset, initialisation process and finalisation process, and the one or more portions of data.

### FIELD AND BACKGROUND

The present techniques relate to communication between computing nodes performing parallel and distributed tasks in the field of high performance computing. More particularly, but not exclusively, the present techniques relate to Message Passing Interface, MPI, collective operations, and network architectures in which MPI collective operations may be performed.

As the growth of parallel and distributed computing has increased, as well as the complexity of applications being run in such systems, there is a need for the performance of computing nodes to increase in a similar way. Further, as the computing nodes are interconnected to perform a distributed task or process, a significant portion of the system performance resides with the techniques with which individual computing nodes communicate with each other.

MPI collective operations are used in high performance computing, HPC, for example distributed deep learning applications, DDL, to control how messages are exchanged between computing nodes running a parallel task or process. However, as identified by the inventors of the present techniques, existing MPI strategies are no longer optimal for meeting the high performance requirements for HPC applications, for example DDL where there is a strong dependence on network performance. Further, the present inventors have identified that existing MPI strategies are not optimal for current network architectures, for example optical circuit switched networks. Indeed, existing MPI strategies and network architectures lead to significant network overheads, high idling time and low operational goodput when performing distributed and parallel computing tasks.

Embodiments of the present disclosure address the problems as set out above. An example network architecture in which the present techniques may be performed will also be described.

### SUMMARY

The invention is defined in the appended claims.

Viewed from a first aspect, there is provided a method for performing a message passing interface, MPI, collective operation in a network, wherein the network comprises a plurality of interconnected nodes, the method comprising: receiving, at a node of the plurality of interconnected nodes, MPI collective operation information identifying the MPI collective operation to be performed, and a graph of the network; determining a number of algorithmic steps of the MPI collective operation based on the MPI collective operation and the graph of the network; determining an initialisation process for the algorithmic steps; determining a finalisation process for the algorithmic steps; determining, for each of the algorithmic steps: a subset of nodes of the plurality of interconnected nodes for the node to communicate with; and one or more portions of the data for the node to send to and receive from the nodes within the subset of nodes; and initialising the MPI collective operation based on the determined subset, initialisation process and finalisation process, and the one or more portions of data.

The present inventors have identified that various MPI operations (such as reduce scatter, all-gather, barrier, all-to-all, scatter, gather, broadcast, and all-reduce) may be characterised by a number of different algorithmic steps (partial collective operations involving a subset of the nodes in the network), where each step requires specific nodes to communicate specific information with other nodes in specific subsets of nodes. The present inventors have identified that in doing so, the MPI operation may be more efficiently performed, and completion times may be reduced, when compared to comparative examples that do not utilise the present techniques.

Viewed from a second aspect, there is provided a node for performing an MPI collective operation on data in network, wherein the network comprises a plurality of interconnected nodes, the node comprising a processor configured to perform the present techniques.

Viewed from a third aspect, there is provided a computer-readable medium comprising instructions which, when executed by a processor, cause the processor to carry out the present techniques.

Viewed from a fourth aspect, there is provided an optical circuit-switched network comprising: a plurality of nodes, each node comprising one or more optical transceivers being configured to implement time-division multiplexing such that each node, at a given time, belongs to one of a plurality of transmitting groups or one of a plurality of receiving groups; a plurality of one-to-many switches, wherein each optical transceiver of each of a transmitting group of nodes of the plurality of nodes is connected to a one-to-many switch of the plurality of one-to-many switches; a plurality of many-to-one switches, wherein each optical transceiver of each of a receiving group of nodes of the plurality of nodes is connected to a many-to-one switch of the plurality of many-to-one switches; and a plurality of optical subnetwork units, wherein each port of each of the one-to-many switches and the many-to-one-switches connects to a different optical subnetwork unit.

Viewed from a fifth aspect, there is provided an electronic-time-division multiplex circuit-switched network comprising: a plurality of nodes, each node comprising one or more transceivers and being configured to implement time-division multiplexing such that each node, at a given time, belong to one of a plurality of transmitting groups or one of a plurality of receiving groups; a plurality of one-to-many switches, wherein each transceiver of each of a transmitting group of nodes of the plurality of nodes is connected to a one-to-many switch of the plurality of one-to-many switches; a plurality of many-to-one switches, wherein each transceiver of each of a receiving group of nodes of the plurality of nodes is connected to a many-to-one switch of the plurality of many-to-one switches; and a plurality of subnetwork units, wherein each port of each of the one-to-many switches and the many-to-one-switches connects to a different subnetwork unit.

Thus, the fourth and fifth aspects provide more efficient communication between transmitting and receiving nodes in the network, resulting in increased network performance, and reduced collective operation completion time. Further, port-level all to-to-all communication is realised, and the resilience of the network is increased as there is no single point of failure.

Viewed from a sixth aspect, there is provided a method for communication in a network according to the fourth aspect, the method comprising: transmitting light, said light encoding data for transmission, from an optical transceiver of a transmitter node, via a port of a one-to-many switch connected to the node, to an optical subnetwork unit connected to the port; receiving light from the optical subnetwork unit at a receiver node via a many-to-one switch connected to the receiver node.

Thus, the efficiency of data communication in the network is increased, as a result of using the present techniques.

Other aspects will also become apparent upon review of the present disclosure particular upon review of the Brief Description of the Drawings, Detailed Description and Claims sections.

### BRIEF DESCRIPTION OF THE DRAWINGS

Examples of the disclosure will now be described, by way of example only, with reference to the accompanying drawings in which:

FIG. 1 schematically illustrates an example network architecture in which the present techniques may be performed.

FIG. 2 schematically illustrates a method according to the present techniques.

FIG. 3 schematically illustrates an example node that may perform the present techniques.

FIG. 4 schematically illustrates a node and algorithm according to the present techniques.

FIG. 5 schematically illustrates an example network architecture according to the present techniques.

FIG. 6 schematically illustrates an example method according to the present techniques.

FIG. 7 schematically illustrates different subnetwork units according to the present techniques.

FIG. 8 schematically illustrates different subnetwork units according to the present techniques.

FIG. 9 schematically illustrates example connectivity of example subnetwork units.

FIG. 10 schematically illustrates an example network and data plane architecture.

FIG. 11 schematically illustrates an example of a many-to-many communication pattern across different time slots between nodes of a) same source-destination communication group pairs and b) different source-destination communication group pairs, and exemplifies the WDM, TDM and SDM properties of the architecture for different communication groups.

FIG. 12 schematically illustrates an example of a) one-to-many, b) many-to-one and c) one-to-one communication patterns at the same time slot between nodes with same source-destination communication group pairs, and exemplifies the WDM, TDM, SDM (across multiple transceivers) properties of the architecture allowing high bandwidth (up to full capacity) communication between one or multiple not-pairs or sets.

FIG. 13 schematically illustrates example subgroups of nodes for each algorithmic step for a 54-node network (x=3, J=3, Λ=6).

FIG. 14 schematically illustrates an example MPI operational process and node architecture according to the present techniques.

FIG. 15 schematically illustrates an MPI operation workflow.

While the disclosure is susceptible to various modifications and alternative forms, specific example approaches are shown by way of example in the drawings and are herein described in detail. It should be understood however that the drawings and detailed description attached hereto are not intended to limit the disclosure to the particular form disclosed but rather the disclosure is to cover all modifications, equivalents and alternatives falling within the spirit and scope of the claimed invention.

It will be recognised that the features of the above-described examples of the disclosure can conveniently and interchangeably be used in any suitable combination.

### DETAILED DESCRIPTION

The present techniques as described herein relate to initialising (preparing nodes so that they may subsequently perform an MPI operation) and performing MPI collective operations. More particularly, the present inventors have identified an approach that allows MPI operations to be more efficiently initialised and performed.

In some examples, a node receives information indicating an MPI operation to be performed and a graph of the network. This information may be received from a job scheduler. Alternatively, this information may be obtained or retrieved by the node.

In some examples, the node also receives a message size of a message associated with the MPI collective operation to be performed, and for each step, determines one or more message sizes of one or more messages for the node to send to the nodes within the subset of nodes, and initialising is further based on the determined one or more message sizes.

The node then determines how many algorithmic steps are required to be able to perform the MPI operation. This determination is based on which MPI operation is to be performed, and the graph of the network, for example the number of other nodes. The present inventors have identified that various MPI operations may be divided into algorithmic steps, where each step requires specific nodes to communicate specific information with other nodes. The present inventors have further identified that in doing so, the MPI operation may be more efficiently performed, with lower completion times.

The node then determines an initialisation process for the algorithmic steps. In some examples, the initialisation process is performed at the beginning of each algorithmic step, or is performed on a received message before subsequent processing of the message takes place. For example, the initialisation process may be a process to be performed before the node sends data to other nodes of the network in the algorithmic step. A finalisation process is then determined. In some examples, the finalisation process may be performed at the end of each algorithmic step, or is performed after the initialisation process. In some examples, the finalisation process is a process to be performed on data or messages received from other nodes of the network in the algorithmic step.

The node then determines, for each of the determined algorithmic steps, a subset of nodes of the network for the node to communicate with at each algorithmic step, and one or more portions of data that the node is to send to other nodes.

Initialising the MPI operation may then comprise storing in a memory of the node the determined information, i.e. the determined initialisation and finalisation processes, and for each step: the subset of nodes, and the one or more portions of data. In examples where the node also receives a message size and determines one or message sizes for each step, the one or message sizes may also be stored in memory. The node may then retrieve this stored data at a subsequent time when a message is received that is to be processed using an MPI operation.

The present techniques may be performed ahead of MPI operation runtime. Thus, when an MPI operation is to be performed, every node involved in the MPI operation has already determined the information required for each node to perform the MPI operation. Accordingly, subsequent performance of the MPI operation on a received message is more efficient, as well as being a more efficient process of performing the MPI operation per se.

It will be appreciated that the present techniques may be performed in any interconnected network, for example any port-level all-to-all network without over-subscription. For example, the present techniques may be performed in existing electrically packet switched or optically circuit switched networks.

In some examples, each node of the plurality of interconnected nodes is configured to perform the method. For example, each node may perform the method simultaneously to determine the information that it will need to be able to perform the identified MPI collective operation on a subsequently received message. Accordingly, the nodes in the network may be able to efficiently process a message using the pre-determined information. In some examples, the plurality of nodes are fully inter-connected.

In some examples, the MPI collective operation information defines an MPI collective operation to be performed. Thus, in these examples, each node may receive an MPI collective operation to be performed and use this to determine the information required to perform the operation.

In some examples, the graph of the network comprises information indicating a hierarchy of the plurality of interconnected nodes. For example, the graph may comprise, for each node, a network-specific coordinate that identifies the hierarchy of the node. In some examples, the coordinate identifies a location of each node relative to other nodes. In this way, each node may efficiently receive information indicating the topology of the network in a format the node is optimised to process.

In some examples, each subset of nodes of each of the algorithmic steps is unique. Thus, each node communicates with a different set of nodes in each algorithmic step, resulting in the more efficient sharing and gathering of information between nodes.

In some examples, determining the number of algorithmic steps is based on retrieving stored information associated with the MPI operation. For example, the node may have stored in memory information associated with a plurality of MPI operations, and the information may identify a number of algorithmic steps for each MPI operation. The node may then lookup the number of algorithmic steps of the received MPI operation based on this stored information. In some examples, each node stores a lookup table comprising information indicating, for each of a plurality of MPI operations, the number of algorithmic steps required to complete the respective MPI operation. In this way, the node may efficiently and independently determine the number of algorithmic steps.

In some examples, the network is a circuit switched network. In other examples, the network is an optical circuit switched network. The present techniques may be particularly effective in such examples, as the present techniques have been particularly optimised for such network architectures.

In some examples, the network comprises one or more clusters, each cluster comprising one or more groups, each group comprising one or more nodes; each node of the plurality of interconnected nodes has a node number within a group, group number within a cluster, and cluster number; and the graph comprises information indicating the node number, group number, and cluster number of each node. Thus, the node receives in an efficient manner information that summarises the network. In some examples, the node number, group number, and cluster number is the coordinate system of the network.

In some examples, a cluster (also referred to as communication group) is a logical group of groups of nodes or racks equal to the radix (the number of transceiver groups of each node in the network). In some examples, the groups (also referred to as racks) are a logical grouping of nodes. In some examples, the groups may be grouped such that the total number of nodes in the network is =number of racks x number of communication groups x number of nodes per rack, the number of nodes per rack is a multiple of the number of communication groups, and the number of racks is less than or equal to the number of communication groups.

As mentioned, the node number, group number and cluster number in some examples are the coordinates that identify the position of a given node within the hierarchy of nodes in the network discussed above. For example, each node may have the following coordinate (g,j,λ), where for the current node g is the cluster number, j is the group number in the cluster, and λ is the node number within the group. Further, as discussed in greater detail below, cluster is used interchangeably with communication group, group is used interchangeably with rack, and node number is used interchangeably with device number. Use of this coordinate information enables each node to efficiently determine the connectivity of other nodes in the network, and is optimised for the techniques for determining the information needed ahead of MPI operation runtime, as discussed in greater detail herein.

In some examples, for a first of the algorithmic steps, the subset of nodes comprises nodes with the same node number, same group number, and different cluster number. Thus, the node may efficiently determine the other nodes that the node needs to communicate with for a first algorithmic step. The node may determine the subset of nodes for each step based on formulae stored in a memory of the node. For example, the node may store a lookup table comprising formulae for determining the subset of nodes for each algorithmic step. This determination may be based on node coordinate information associated with the graph of the network.

In some examples, the plurality of nodes in each group are divided into node sets comprising x nodes, where each node has a unique node set number from 1 to x, and where x is the number of clusters. The present inventors have identified that, by dividing nodes in this manner, the present techniques and formulae discussed later herein may be more efficiently performed and used. Consequently, nodes are able to determine the information required for performing an MPI operation more efficiently.

In some examples, for a second of the algorithmic steps, the subset of nodes comprises nodes with sequential node number in the same node set, the same group number, and different cluster number. Thus, the node may efficiently determine the other nodes that the node needs to communicate with for a second algorithmic step.

In some examples, for a third of the algorithmic steps, the subset of nodes comprises nodes with the same node number, different group number, and different cluster number. Thus, the node may efficiently determine the other nodes that the node needs to communicate with for a third algorithmic step.

In some examples, for a fourth of the algorithmic steps: the subset of nodes comprises nodes with the same node number in a node set, different node sets, same group numbers, and different clusters; or the subset of nodes comprises nodes in sequential node sets with the same node number in a node set, the same group number and different cluster number. Thus, the node may efficiently determine the other nodes that the node needs to communicate with for a fourth algorithmic step.

Accordingly, for each of the determined algorithmic steps, the node is able to determine the other nodes in the subset that the node will need to communicate with in an efficient manner.

In some examples, the network comprises x clusters; each cluster comprises J groups, wherein J≤x; each group comprises/nodes; each cluster has a cluster number, g, defined by 0≤g≤x−1; each node has a node number in a group, λ, defined by 0≤λ≤Λ−1; each group has a group number, j, defined by 0≤j≤J−1; and the plurality of nodes in each group are divided into node sets comprising x nodes, where each node has a unique node number in the node set from 1 to x. In some examples, if Λ>x², then the dividing of nodes into node sets is performed multiple time such that there are smaller node sets, and in some example the fourth step will be repeated as many time as this partition is performed such that it works across partitions. The present inventors have identified that organising the nodes in such a manner is optimised for the present techniques and formulae discussed later herein, allowing more efficient performance of the techniques.

In some examples, a subset of the nodes in the network may form the network of nodes. In this case, the algorithm is valid also for a subset of nodes, by making x, J, Λ the number of communication groups, racks and unique node/device IDs used by the subset of nodes (dependent on the node placement/selection) in the whole graph.

In some examples, for a first of the algorithmic steps, the total number of subsets of nodes=ΛJ, each subset having an identifier, i; the total number of nodes per subset is x; and for the first of the algorithmic steps, the identifier of the subset is determined based on the following formula: i=λ+Λ·j. Thus, the node is able to use the coordinate information and graph of the network to efficiently determine, for the first algorithmic step, the number of subsets, the identifiers of the subset, and the number of nodes per subset. In examples where each node performs the present techniques, each node therefore independently has the required information, leading to increased resilience.

In some examples, for a second of the algorithmic steps, the total number of subsets of nodes=ΛJ; the total number of nodes per subset is x; and for the second of the algorithmic steps, the identifier of the subset is determined based on the following formula: i=(λ−g) mod x+Λj+ └Λ/x┘x. Thus, the node is able to use the coordinate information and graph of the network to efficiently determine, for the second algorithmic step, the number of subsets, the identifiers of the subset, and the number of nodes per subset.

In some examples, for the third algorithmic step, the total number of subsets of nodes=Λx; the total number of nodes per subset is J; and for the third algorithmic step, the identifier of the subset is determined based on the following formula: i=(λ+Λ(j−g)) mod (Λj). Thus, the node is able to use the coordinate information and graph of the network to efficiently determine, for third second algorithmic step, the number of subsets, the identifiers of the subset, and the number of nodes per subset.

In some examples, for the fourth algorithmic step, the total number of subsets of nodes=Jx²; the total number of nodes per subset is Λ/x; and for the fourth algorithmic step, the identifier of the subset is determined based on the following formula: i=(λ−└λ/x┘x) mod x+x²j+ ((g−j└λ/x┘) mod x) x; or i=x²j+x[(g−└λ/x┘)mod x]+λ mod x. Thus, the node is able to use the coordinate information and graph of the network to efficiently determine, for the fourth algorithmic step, the number of subsets, the identifiers of the subset, and the number of nodes per subset.

In some examples, the method further comprises: responsive to determining that the MPI operation is a reduce scatter operation, selecting as the initialisation process a reshape process and selecting as the finalisation process a reduce process; responsive to determining that the MPI operation is an all-gather operation, selecting as the initialisation process a copy process and selecting as the finalisation process an identity process; responsive to determining that the MPI operation is a barrier operation, selecting as the initialisation process an identity process and selecting as the finalisation process a logical AND process; responsive to determining that the MPI operation is an all-to all operation, selecting as the initialisation process a reshape process and selecting as the finalisation process a reshape process; responsive to determining that the MPI operation is a scatter operation, selecting as the initialisation process a reshape process and selecting as the finalisation process an identity process; responsive to determining that the MPI operation is a gather operation, selecting as the initialisation process a copy process and selecting as the finalisation process an identity process; responsive to determining that the MPI operation is a broadcast operation, selecting the processes associated with the scatter operation and the all-gather operation; and responsive to determining that the MPI operation is an all-reduce operation, selecting the processes associated with the reduce-scatter operation and all gather operation.

Thus, the node may determine the type of MPI operation and use a lookup table of processes to perform that depend on the MPI operation. As mentioned, the present inventors have identified that various MPI operations (reduce scatter, all-gather, scatter, gather, etc.) may be characterised by a combination of processes performed on data during each step of the algorithm. This results in more efficient performance of the MPI operation, with reduced completion time and higher throughput.

In some examples, for a first of the algorithmic steps, the one or more portions of data is determined based on the following: portion of data=(g−λ−j−└λ/x┘j) mod x; for a second of the algorithmic steps, the portion of data is determined based on the following: portion of data=(g−j−└λ/x┘j) mod x; for a third of the algorithmic steps, the portion of data is determined based on the following: portion of data=j; and for a fourth of the algorithmic steps, the portion of data is determined based on the following: portion of data=└λ/x┘.

As mentioned, at each algorithmic step, each node determines the portion of the received message to send onto another node or other nodes in their subset. In some examples, the matrix is a defined size. In some examples, the message is a vector or array or matrix, and each element in the vector/array/matrix has an index. The node may therefore, on a received message (either the original message at the start of the process or on a message received from another node in the subset during a previous algorithmic step, and after performing the initialisation process on the received message, determine the portions of the message that each other node in the subset should receive. In particular, as the node has determined the coordinates of all the other nodes in the subset, the node may utilise the above formulae and for each coordinate of each node in the subset, determine the portion of the message that the node should receive. For example, a portion=2 may correspond to the third element in [0, 1, 2, n]. Thus, the node knows for each other node in the subset and for each algorithmic step, what portion of the message each node needs to receive.

At runtime, the node may send the determined portion or portions to the respective node or nodes. Thus, information is shared in an efficient manner, and each node is aware of how information is being shared in their subset of nodes.

In some examples, a received message size is m, the method further comprises: responsive to determining that the MPI operation is a reduce scatter operation: for a first of the algorithmic steps selecting the size of a message as m/x, for a second of the algorithmic steps selecting the size of a message as m/x², for a third of the algorithmic steps selecting the size of a message as m/(Jx²), for a fourth of the algorithmic steps selecting the size of a message as m/(JΛx); responsive to determining that the MPI operation is an all-gather operation: for a first of the algorithmic steps selecting the size of a message as m·JΛx, for a second of the algorithmic steps selecting the size of a message as m·JΛ, for a third of the algorithmic steps selecting a size of the message as m·JΛ/x, for a fourth of the algorithmic steps selecting the size of a message as m·Λ/x; responsive to determining that the MPI operation is a barrier operation: for a first of the algorithmic steps selecting the size of a message as 0, for a second of the algorithmic steps selecting the size of a message as 0, for a third of the algorithmic steps selecting the size of a message as 0, for a fourth of the algorithmic steps selecting the size of a message as 0; responsive to determining that the MPI operation is an all-to-all operation: for a first of the algorithmic steps selecting the size of a message as m/x, for a second of the algorithmic steps selecting the size of a message as m/x, for a third of the algorithmic steps selecting the size of a message as m/J, for a fourth of the algorithmic steps selecting the size of a message as m·x/Λ; responsive to determining that the MPI operation is a scatter operation: for a first of the algorithmic steps selecting the size of a message as m/x, for a second of the algorithmic steps selecting the size of a message as m/x², for a third of the algorithmic steps selecting the size of a message as m/(Jx²), for a fourth of the algorithmic steps selecting the size of a message as m/(JΛx); responsive to determining that the MPI operation is a gather operation: for a first of the algorithmic steps selecting the size of a message as m·JΛx, for a second of the algorithmic steps selecting the size of a message as m·JΛ, for a third of the algorithmic steps selecting the size of a message as m·JΛ/x, for a fourth of the algorithmic steps selecting the size of a message as m·(Λ/x); and responsive to determining that the MPI operation is a broadcast operation: determining the size of a message for each step based on a message size determined from a scatter and all-gather operation. In some examples, responsive to determining that the MPI operation is a broadcast operation: determining the size of a message for each step is based on the following: message size=m/k; and number of steps=s+k−2s, where k=√((m·(s−2))/α β), s is the diameter of the tree generated to perform the broadcast, α is communication setup latency, and β is the inverse of the total node capacity. In some examples, the determined message size corresponds to the send of a message that the node will send to other nodes in each communication step. In some examples, the maximum value of s is 3.

Thus, the node (or each node participating in the collective operation) is able to determine the size of the message for each algorithmic step, and keep track of the total message size. The present inventors have identified that such a series of relationships and formulae allows for the efficient determination of message size at each step.

In some examples, the method further comprises, responsive to determining that the step or MPI operation to be performed is all-gather or reduce-gather or gather, the algorithmic steps are performed in the reverse order. In other words, the steps in tables 1 to 4 presented below are performed in the reverse order, such that step 4 is performed first, then step 3, then step 2, then step 1.

In some examples, the method further comprises, for each of the algorithmic steps, storing in memory the determined subset of nodes, and one or more portions of data, and optionally the one or more message sizes.

In some examples, the method further comprises:
after initialising the MPI operation, receiving a message associated with the MPI collective operation;
performing a first of the algorithmic steps by:
   processing the message with the determined initialisation process;
   sending the determined one or more portions of the processed message to the respective node or nodes of the subset;
   receiving a message from a node within the subset; and
   processing the received message with the finalisation process, wherein the processed received message becomes the message for the subsequent algorithmic step, and wherein performing of the algorithmic steps is repeated for all of the determined algorithmic steps using the determined respective information for each step.

Thus, once the nodes have determined the information to enable performance of an MPI operation, and stored that information in memory, when a message to be processed using that MPI operation is subsequently received, the nodes may then process that message efficiently and using the information they have stored.

In some examples, after initialising the MPI operation, the method further comprises performing the MPI operation on a received message based on based on the determined subset of nodes, the one or more portions of data, the initialisation process, and the finalisation process for each respective step.

In some examples, performing each of the algorithmic steps comprises providing a network transcoder of the node with the determined subset of nodes and the one or more data portions, the method further comprising, translating, by the network transcoder, the determined subset of nodes and the one or more data portions into instructions for configuring one or more transceivers of the node. Thus, the nodes may comprise a network transcoder configure to transcode information determined by the node into instructions for a network interface card of the node, or a transceiver of the node.

In some examples, the network is an optical network that comprises a plurality of parallel subnets, each subnet connected to a splitter and a combiner and a plurality of transceivers. Thus, in these examples, the present techniques are combined with optical networking techniques, which as discussed herein, reduce the MPI operation completion time and reduce contention. Thus, collective operations may be performed more efficiently. Additionally, the use of an optical network rather than an EPS network further increases the performance improvements of the techniques, reduces overall energy usage of the network, and infrastructure cost.

In some examples, the network is an optical network comprising a plurality of transceivers with all-to-all connectivity. In this way, the nodes may achieve unrestricted multi-node communication and reliability in respect of network component failure. For example, communication between any node pair is possible if a transceiver or subnet breaks.

Thus, there has been described techniques for efficiently initialising an MPI operation, and for more efficient performance of the MPI operation. Particular examples will now be described with reference to the figures.

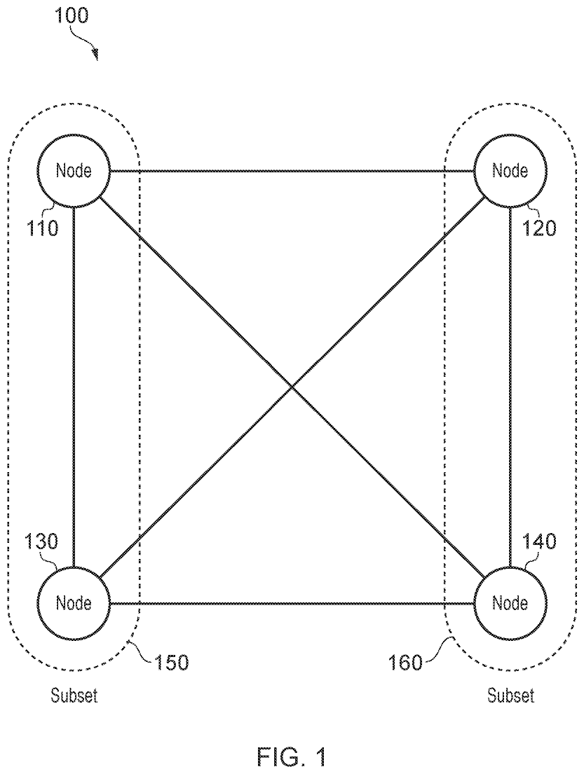

FIG. 1 schematically illustrates an example network architecture or topology 100 in which the present techniques may be performed. The network architecture 100 comprises a plurality of nodes 110, 120, 130, and 140 that are interconnected, as indicated by the solid lines. It will be appreciated that the network may comprise any plurality of nodes, and may also comprise non-interconnected nodes. Nodes 110, 120, 130, 140 are configured to communicate with each other, for example by way of a packet switched or circuit switched network architecture (not shown), such as an electrically packet switched or optical circuit switched (OCS) network. In examples that use OCS, the network comprises one or more optical devices. The nodes comprise communication circuitry for communicating with other nodes in the network.

Each node may perform the present techniques, and in some cases each node may perform the present techniques simultaneously. Thus, during each algorithmic step, each node may send data to another or other nodes in their subset, and also receive data from at least one other node in the subset. Subsets 150 and 160 comprise nodes 110, 130 and 120, 140 respectively. Subsets 150, 160 (also referred to herein as subgroups) comprise the group of nodes that will communicate for each algorithmic step. Thus, FIG. 1 shows two possible subsets of nodes for an algorithmic step.

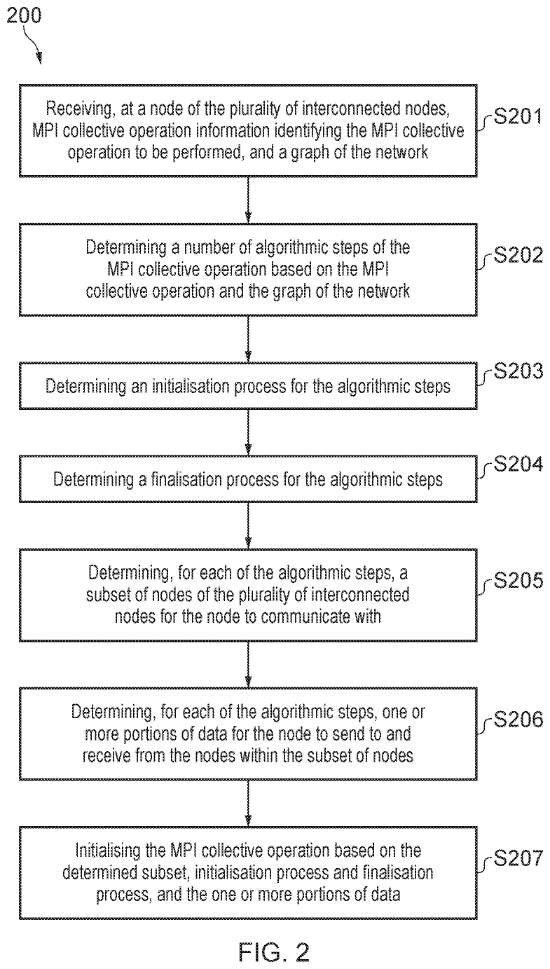

FIG. 2 schematically illustrates a method 200 according to the present techniques. Method 200 may be performed by a or each node 110, 120, 130, 140 in network 100.

At S201, a node of the plurality of interconnected nodes receives MPI collective operation information identifying the MPI collective operation to be performed, and a graph of the network.

As discussed above, the graph of the network may contain a coordinate of each node in the network indicating a hierarchy of that node, and information indicating the total number of clusters, total number of groups per cluster, and total number of nodes in each group.

At S202, the node determines a number of algorithmic steps of the MPI collective operation based on the MPI collective operation and the graph of the network. For example, the node may have stored in memory a look-up table associated with the number of algorithmic steps for each of a plurality of MPI operations. The node may therefore determine the number of algorithmic steps based on this look-up table.

At S203, the node determines an initialisation process for the algorithmic steps. The node may determine the initialisation process based on the MPI collective operation. The node may have stored in memory a look-up table associated with initialisation processes for each of a plurality of MPI operations. The node may therefore determine the initialisation process based on this look-up table. The initialisation process may be a process to be performed on received data before that data is portioned and sent to other nodes in the subset.

At S204, the node determines a finalisation process for the algorithmic steps. The node may determine the finalisation process based on the MPI collective operation. The node may have stored in memory a look-up table associated with finalisation processes for each of a plurality of MPI operations. The node may therefore determine the finalisation process based on this look-up table. The finalisation process may be a process that is performed on data received from other node(s) during each algorithmic step.

At S205, the node determines, for each of the algorithmic steps, a subset of nodes of the plurality of interconnected nodes for the node to communicate with. The node may have stored in memory formulae for determining the subset of nodes for each algorithmic step. Determining the subset may be based on the graph of the network, for example the coordinates of the nodes in the network.

In some examples, determining the subset of nodes comprises:
a. determining an identifier of the subset the node is in, based on information relating to the position of the node in the network;
b. determining a number of nodes in the subset; and
c. determining the other nodes within the subset, for example based on the graph of the network.

At S206, the node determines, for each of the algorithmic steps, one or more portions of data for the node to send to and receive from the nodes within the subset of nodes. For example, each node may have stored in memory formulae for determining the portions of data that each node in the subset should receive in an algorithmic step.

At S207, the node initialises the MPI collective operation based on the determined subset, initialisation process and finalisation process, and the one or more portions of data.

In some examples, the node determines, for each of the algorithmic steps, one or more message sizes of one or more messages for the node to send to the nodes within the subset of nodes. For example, the node may determine the one or more message sizes for the node to send to the other nodes of the subset based on a received message size. In some examples, the node may have stored in memory formulae for determining the one or more message sizes based on the received message size.

As discussed herein, initialising the MPI collective operation may comprise storing in memory the determined subset, initialisation process and finalisation process, the one or more portions of data, and optionally the determined one or more message sizes (for each step where relevant).

Thus, the node may efficiently determine the information required for the node to efficiently perform an MPI operation.

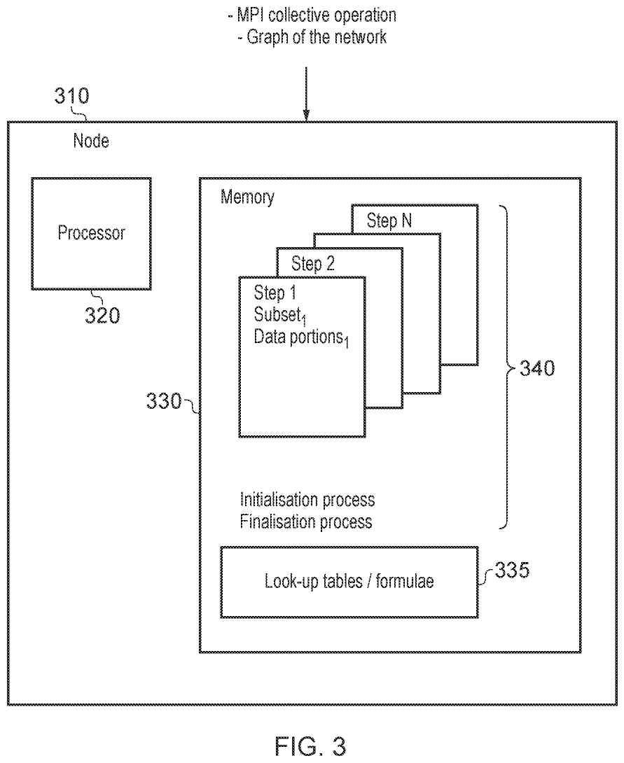

FIG. 3 schematically illustrates an example node 310 that may perform the disclosed techniques, for examples those of method 200. Node 310 may perform the techniques in the network architecture of FIG. 1. Node 310 comprises a processor 320 (or processing circuitry) and memory 330, as well as communication circuitry for communicating with other nodes (not shown).

As shown, node 310 receives or otherwise obtains an MPI collective operation to be performed (or information identifying an MPI collective operation to be performed), and a graph of the network. Node 310 comprises processor 320 configured to perform the processing required for the present techniques. Node 310 then performs the method of 200. As a result, the node 310 determines information 340 and stores information 340 in memory 330. Node 310 has stored in memory 330 look-up tables and formulae 335, which are used to determine the information 340.

Information 340 comprises the determined initialisation process, the determined finalisation process, and for each step in the number of algorithmic steps N: the subset of nodes, and the one or more data portions.

Thus, at a subsequent time, when a message is received that is to be processed using the MPI collective operation, the node has the information required and the MPI collective operation may be performed using the present techniques.

The look-up tables and formulae 335 used by the node to determine the number of algorithmic steps, initialisation process, finalisation process, subset of nodes for each step, one or more data portions for each step, and optionally the message size per step will now be described. These tables are further described under the ‘Worked example’ section further below.

As discussed earlier, the graph may comprise coordinate information for each node involved in the collective operation. The graph may also comprise information indicating the following: the network comprises x clusters; each cluster comprises/groups, wherein J≤x; each group comprises/nodes; each cluster has a cluster number, g, defined by 0≤g≤x−1; each node has a node number in a group, λ, defined by 0≤λ≤Λ−1; each group has a group number, j, defined by 0≤j≤J−1.

Indeed, as discussed earlier, the network may comprise clusters, groups of nodes within each cluster, and nodes within each cluster. This coordinate information may take the form: (g,j,λ), where for the current node g is the cluster number, j is the group number in the cluster, and λ is the node number within the group.

The following tables may be stored in memory of the node (or each node) and be used to determine the information 340. Subgroup is used interchangeably with subset of nodes herein.

Table 1: shows subgroup ID selection. #SG is the number of subgroups, #NS is the number of nodes per subgroup.

| Step | #SG | #NS | Subgroup ID formula |
|---|---|---|---|
| 1 | ΛJ/x | x | λ + Λ · j |
| 2 | ΛJ/z | x | (λ − g) mod x + Λj + [λ/x]x |
| 3 | Λx/J | J | (λ + Λ(j − g)) mod (Λj) |
| 4 | Jx² | Λ/x | 1) (λ − [λ/x]x) mod x + x²j + |
| | | | ((g − j[λ/x]) mod x)x |
| | | | or |
| | | | 2) x²j + x [symbol] (g − [λ/x]) mod x [symbol] + d mod x |

[symbol]

indicates data missing or illegible when filed

Table 2: shows message size and buffer and local operations per step of various MPI collective operations. Buffer operation is used interchangeably with initialisation process and local operation is used interchangeably with finalisation process herein.

| | | Message size per step (m = original message size) | | | | Local Ops. | |
|---|---|---|---|---|---|---|---|
| | | 1 | 2 | 3 | 4 | Op. | Buff_Op |
| MPI | Red-Scatter | m/x | m/x² | m/(Jx²) | m/(JΛx) | Reduce | Reshape |
| Operations | All-Gather | m · Λ/x | m · JΛ/x | m · JΛ | m · JΛx | Identity | Copy |
| | Barrier | 0 | 0 | 0 | 0 | Logical and | Identity |
| | All-to-All | m/x | m/x | m/J | m · x/Λ | Reshape | Reshape |
| | Scatter | m/x | m/x² | m/(Jx²) | m/(JΛx) | Identity | Reshape |
| | Gather | m · Λ/x) | m · JΛ/x | m · JΛ | m · JΛx | Identity | Copy |

| | | | |
|---|---|---|---|
| Broadcast | m/k for s + k − 2s steps | Identity | Identity |

Table 3: formula describing what portion of the previous message should be received by a node at any algorithmic step.

| Step | Information portion formula |
|---|---|
| 1 | (g − λ − j − [λ/x]j) |
| | mod [symbol] |
| 2 | (g − j − [λ/x]j) mod x |
| 3 | j |
| 4 | [λ/x] |

[symbol]

indicates data missing or illegible when filed

Table 4: formulae to calculate the coordinate (cluster number, group number in cluster, node number in group, also referred to as communication group, rack number, device number) of the other nodes of the subgroup of the current. The current node having coordinates (g,j,λ) at any algorithmic step. The variable column shows the range of the variable for describing all members of the subgroup.

| Step | Communication Group | Rack | Device ID | Variable |
|---|---|---|---|---|
| 1 | (g + γ)modx | j | λ | 0 ≤ γ ≤ x − 1 |
| 2 | (g + γ)modx | j | (λmodx + γ)modx + | 0 ≤ γ ≤ x − 1 |
| | | | x[λ/x] | |
| 3 | (g + γ)modx | (j + γ)modJ | λ | 0 ≤ γ ≤ J − 1 |
| 4 | (g + j − | j | λmodx + x × | NA |
| | [symbol] ([λ/x] + 1)/[Λ/x] [symbol] × | | [symbol] ([λ/x] + 1)mod[Λ/x] [symbol] | |
| | ([λ/x] + 1) [symbol] j)modx | | | |

[symbol]

indicates data missing or illegible when filed

Table 1 may be used to determine the number of algorithmic steps for the MPI operation. Table 1 may be used to determine the subsets of nodes that the node is to communicate with at each algorithmic step. As shown, for each step, the number of subgroups, the number of nodes per subgroup, and the subgroup identifier may be determined using the graph information, i.e. g, x, λ, J, j, Λ. The coordinates of the other nodes in the subgroup may be determined using table 4.

In some examples, if the calculated number of nodes per subgroup=1 for an algorithmic step, that algorithmic step is skipped.

Table 2 may be used to determine the initialisation and finalisation processes to perform. As shown, the Buff_op, or buffer operation, or initialisation process, may be one of a number of processes, dependent on the MPI operation to be performed. For example, the initialisation process may be a reshape, copy, or identity process. The Op, or local operation, or finalisation process, may be a reduce, identity, reshape, logical AND process. The combination of the initialisation and finalisation (or buffer and local operations) are specific to/depend on the MPI operation to be performed.

Table 3 may be used to determine the one or more data portions for each algorithmic step. The table comprises formulae for calculating the portion of the message (for example the index of the vector message) that each node in a subset should receive in each algorithm step. The formulae take the coordinates and graph information as an input.

Thus, using tables 1, 2, 3, and 4 stored in memory the node may be able to determine the information 340 needed to be able to perform the MPI collective operation. As discussed, the information 340 may then be stored in memory ahead of runtime of the MPI operation.

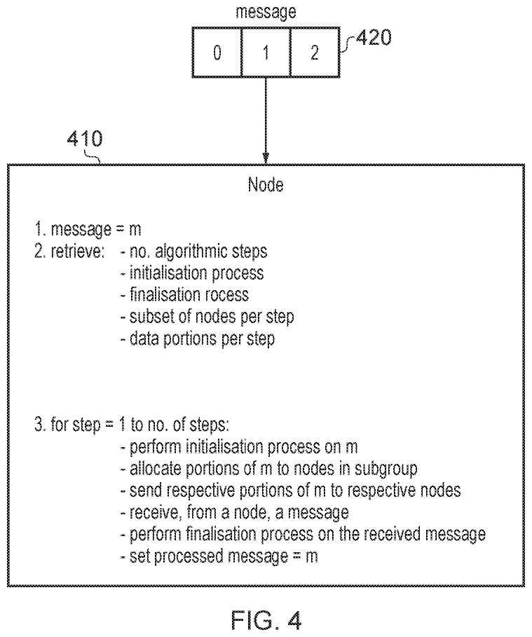

FIG. 4 schematically illustrates an algorithm/method a node 410 performs after the node has been initialised with the information described above, and when a message is received. Node 410 may be node 310 or any of nodes 110, 120, 130, 140 within network 100.

Node 410 receives a message 420 that is to be used in an MPI operation (for which the node has stored all of the required information). Message 420 may be an array, vector or matrix with a defined length. As shown, message 410 is a vector split into N=3 portions, each portion labelled by an index 0, 1, or 2. It will be appreciated that the exact form of the message, its division, and indexing may vary depending on implementation.

Steps 1, 2, 3 demonstrate a pseudo-code version of the process that the node 420 then performs after receipt of the message. After node 420 receives the message, the node 1. sets the received message=m, and 2. retrieves the information relevant for the MPI operation to be performed. In particular, the node 410 retrieves from memory the number of algorithmic steps associated with the MPI operation, the initialisation process associated with the MPI operation, the finalisation process associated with the MPI operation, the subset of nodes to communicate with at each step, and the data portions that each node should receive at each step.

At step 3, the node 410 processes the message. In particular for each step in the number of algorithmic steps, the node performs the initialisation process on m. The node then allocates portions of m to nodes in the subgroup based on the determined one or more portions. For example, the portion of the message with index 0 may be allocated to node x, index 1 may be allocated to node y, and index 3, may be allocated to node z (where nodes x, y, z are members of the subset of nodes for that step). In other words, using the stored one or more data portions, the part of the message that each node needs to receive in terms of the index of these N portions is allocated to the respective node.

The node 410 then sends the respective portions of the message to the respective node or nodes. In the same algorithmic step, the node receives a message from a node in the subset. The node 410 performs the finalisation process on the received message, and sets this processed message=m for use as the message for the next algorithmic step. This process is repeated for all of the algorithmic steps, using the information specific to each algorithmic step, until the operation is finished.

Thus, there has been described a method for efficiently performing an MPI operation.

Example network architectures in which the present techniques may be performed will now be described. It will also be appreciated that the present techniques may be performed in other network architectures while achieving one or more of the discussed advantages. The example network architectures provide improved performance, for example improved performance of the MPI collective operations discussed herein. It will be appreciated that any of nodes 110, 120, 130, 140, 310, 410 may operate in the below network architectures, and perform method 200. The following advantages can be achieved by the network architectures presented herein:
a) Port level all-to-all connectivity at large scale. For example, each transceiver may be fully connected. In other words, the transceivers of the present architectures are not partially connected.
b) Full-capacity node-to-node connectivity. In other words, the present architectures are not limited by a single transceiver per source destination pair.
c) High-capacity (for example>12.8 Tbps, or >10 Tbps) and large scale (for example>4096 nodes) communication may be realised.
d) High-reliability, with no single point of failure.
e) Suitable for both HPC and DCN application.
f) Dynamic trade-off of bandwidth and connectivity.

Indeed, there is provided an optical circuit-switched network comprising: a plurality of nodes, each node comprising one or more optical transceivers being configured to implement time-division multiplexing such that each node, at a given time, belongs to one of a plurality of transmitting groups or one of a plurality of receiving groups; a plurality of one-to-many switches, wherein each optical transceiver of each of a transmitting group of nodes of the plurality of nodes is connected to a one-to-many switch of the plurality of one-to-many switches; a plurality of many-to-one switches, wherein each optical transceiver of each of a receiving group of nodes of the plurality of nodes is connected to a many-to-one switch of the plurality of many-to-one switches; and a plurality of optical subnetwork units, wherein each port of each of the one-to-many switches and the many-to-one-switches connects to a different optical subnetwork unit.

In some examples, the optical circuit-switched network comprises port-level connectivity. For example, the plurality of nodes may have port-level connectivity.

In some examples, the transceivers of nodes of the transmitting group are transmitters and the transceivers of nodes of the receiving group are receivers.

In some examples, each optical subnetwork unit is configured to connect a respective different set or cluster of nodes belonging to the transmitting and receiving groups.

In some examples, each node comprises a plurality of optical transceivers. Thus, the number of available paths in the network is increased, resilience of the network due to additional paths is increased, and the communication capability per node is increased. Further, unrestricted communication between pairs of nodes is realised, and the bandwidth is increased.

In some examples, each optical subnetwork units is an optical coupling subnetwork unit or a subnetwork routing unit.

In some examples, the network comprises one or more clusters, each cluster comprising one or more groups, each group comprising one or more of the plurality of nodes; the number of clusters is x, the number of groups per cluster is J, and the number of nodes per group is Λ, wherein J<=x; and the number of nodes per group, Λ, is equal to a number of different wavelength channels available in the network, said optical transceivers being tuneable to transmit and/or receive on said different wavelengths whereby to select a given node with which to communicate.

In some examples, each optical subnetwork unit is configured to connect the same port of the respective one-to-many and many-to-one switches of nodes in different cluster pairs. In some examples, there is a unique subnetwork unit for each cluster pair per transceiver. Thus, nodes in different cluster pairs are able to communicate efficiently.

In some examples, different optical subnetwork units connect different sets of nodes. Thus, full connectivity may be achieved.

In some examples, each optical subnet work unit comprises JΛ×Λ star couplers each connected to a port of JΛ filter arrays, each configured to select a different wavelength. Thus, the network is able to efficiently communicate between nodes.

In some examples, Λ is equal to the number of different wavelength channels available in each subnet unit. In some examples, Λ is equal to the number of wavelengths each laser in the system can transmit and/or each tunable filter can receive. Further, each node may have fixed a transmitter and tunable receiver. Thus, full utilisation of the available wavelengths in the network is provided. Accordingly, network and hardware resources are used more efficiently. Further, the present inventors have identified that this arrangement provides improved communication performance between nodes.

In some examples, each node comprises bx transceivers grouped into x transceiver groups, each group having b transceivers. In some examples b=1, in other examples b is more than 1.

For example, each transceiver is connected to a different set of subnet units, to communicate to the same transceiver of all nodes. The number of transceiver groups x may be equal to the number of communication groups (also referred to as clusters), such that each node can transmit information to all communication groups at same time. This increases the efficiency of communication between nodes, and is particularly useful for HPC applications.

Further, in an example, each transceiver group may act independently, and transmit and receive from any node at any time step. This means that the same node can transmit at the same time to multiple nodes using different transceivers. Each node can transmit at the same time to either: nodes of different clusters and group, nodes of different clusters and same group, nodes of same cluster different groups, same cluster same group different nodes, same cluster same group same node using full-capacity. This results in unrestricted communication between node pairs, and increased bandwidth connectivity between node pairs or node sets by using multiple transceivers in parallel. Whereas in a comparative example, labelled PULSE, there is a single connection between any node pair and so the bandwidth cannot be increased. In addition, in PULSE, whenever a connection is set, the node will not be able to communicate to Λx−1 nodes, as there is only a single transceiver which handles the connection to/from all nodes with the same group number of all clusters.

In some examples, the b transceivers of a given transceiver group are configured to receive respective optical inputs from shared optical source circuitry. Thus, resources in the network are more efficiently utilised. In some examples, the optical source circuitry is a tunable laser. In some examples, the b transceivers of a given transceiver group share the same control. In some examples, all transceivers in a given transceiver group may share tunable source and control both for switches and tunable filters if necessary.

In some examples, at a given time: the b transceivers of a given transceiver group are configured to transmit to a given optical transceiver of a given receiving group; and the transceivers of a second given transceiver group are operable to transmit to at least one of the given optical transceiver of the given receiving group and a second optical transceiver of a second, different, receiving group.

Thus, the transceivers of a group may transmit to the same destination to increase aggregate bandwidth. Further, as each transceiver group may be independent, transceiver groups can transmit to different or the same destination at the same time. Accordingly, bandwidth and connectivity is further increased.

In some examples, a total number of optical subnetwork units in the network is bx³. The present inventors have identified that this number of subnetwork units is particularly suited for the network architecture, and results in increased connectivity in the network.

In some examples, each optical subnetwork unit has a radix of ΛJ×ΛJ. In other words, the number of input/output ports of the subnetwork unit is ΛJ×ΛJ. The present inventors have identified that this arrangement provides increased connectivity in the network.

For example, the architecture may be a subnet-based architecture, where different subnets (referred to interchangeably herein as optical subnetwork units) connect different sets of nodes. Each subnet connects the same port of all nodes in different cluster pairs. Each subnet may be a ΛJ×ΛJ network device. It may comprise of either a combination of ΛJ×Λ broadcast (OCS) or routing (wavelength routing OCS) elements followed by ΛJ×J broadcast (OCS) or switching (OCS) elements, or J arrays of Λ fixed filters (single wavelength) or amplifiers (SOA or others) or Λ J×1 WDM multiplexer followed by Λ 1×J tunable demultiplexing filter (each port removes one wavelength chosen actively).

In some examples, the network comprises bx paths between a node in the transmitting group and a node in the receiving group. Thus, fault tolerance and reliability is increased. If a subnet fails, communication between all nodes is still possible with the only difference being that the transmitter connected to that subnet cannot be used. Further, the number of paths and the number of transceivers may create duplicate copies of the network.

In some examples, the one-to-many switch is configured to select a given node of said receiving group, to receive transmitted data; and the many-to-one switch is configured to select a given node of said transmitting group to transmit the transmitted data. Thus, the switches may efficiently perform source and destination/path selection. In some examples, the port of the one-to-many switch determines the destination communication group. In some examples, the port of the many-to-one switch determines the source destination group.

In some examples, the optical subnetwork units are configured to perform one of the following techniques: broadcast and select, route and broadcast, and route and switch, broadcast filter amplify and broadcast, broadcast filter and switch, broadcast filter multiplex, and demultiplex. The present inventors have identified that these techniques allow for the efficient communication between nodes.

In some examples, each said optical subnetwork unit comprises one or more of: a star coupler, a filter, a space switch, a semiconductor optical amplifier, an arrayed waveguide grating router, AWGR, a multiplexer, and tunable add and drop demultiplexer filters. Thus, the subnetwork unit may be configured for specific network configurations, for example depending on the fixed/tuneable type of transceivers used. Thus flexibility is increased.

In some examples, each optical transceiver comprises: a tuneable transmitting element and a fixed-wavelength filtering receiving element; a tuneable transmitting element and a tuneable filtering receiving element; a fixed-wavelength transmitting element and a tuneable filtering receiving element; or a tuneable transmitting element and a filter-less receiving element. Thus, various forms of transceiver may be used, depending on use case. Thus flexibility is increased. Optionally, the filtering receiving (and filter-less)_elements may be connected to the many-to-one switch. In other words, filtering may be performed before the many-to-one-switch or switches. In other words, the filtering element may be before each ingress port of the many-to-one switch. In some embodiments, the filtering element is directly connected to each/any/a port of the many to one switch.

In some examples, the each one-to-many switch comprises one or more space switches configured in use to activate each port of each one-to-many switch to select the respective optical subnetwork unit connected to the activated port. In particular, each port of the subnetwork unit connects to a different cluster. In some examples, the space switches may comprise a semiconductor optical amplifier.

In some examples, one or more of the one-to-many switches are semiconductor optical amplifier based switches, and wherein one or more of the many-to-one switches are semiconductor optical amplifier based switches. In some examples, one or more of the one-to-many switches are semiconductor optical amplifier gated splitters, and wherein one or more of the many-to-one switches are semiconductor optical amplifier gated couplers. Thus, fast switching times may be achieved. In some examples, depending on the type of space switch, splitter and couplers are not required.

A list of network resources that may be made accessible to each node may be: transceiver group (2D: b,x), wavelength, space/path and timeslot, (xDM: SDM, WDM, TDM, Transceiver).

In some examples, the one-to-many switch selects the destination cluster the node will send to and the many-to-one switch selects which source cluster the receiver receives from. Further, wavelength selection may be used to select destination/source node in a group (WDM-node selection). Switch port selection may be used to select destination and source clusters (cluster selection). Broadcast or switching between nodes with same node number in group of all groups of the same cluster within same subnet (group selection). This may all be performed at transceiver level.

Further, communication may be active in synchronous slots, where one or multiple transceivers can communicate to one or multiple destinations in the same time-slot. In this manner, one or multiple transceivers can be used between node pairs and sub-set of nodes. This allows for up-to full-capacity communication between node pairs.

There is also provided an electronic-time-division multiplex circuit-switched network comprising: a plurality of nodes, each node comprising one or more transceivers, and being configured to implement time-division multiplexing such that each node, at a given time, belong to one of a plurality of transmitting groups or one of a plurality of receiving groups; a plurality of one-to-many switches, wherein each transceiver of each of a transmitting group of nodes of the plurality of nodes is connected to a one-to-many switch of the plurality of one-to-many switches; a plurality of many-to-one switches, wherein each transceiver of each of a receiving group of nodes of the plurality of nodes is connected to a many-to-one switch of the plurality of many-to-one switches; and a plurality of subnetwork units, wherein each port of each of the one-to-many switches and the many-to-one-switches connects to a different subnetwork unit.

In some examples, each subnetwork unit is configured to connect a respective different set or cluster of nodes belonging to the transmitting and receiving groups.

In some examples, the subnets are JΛ×Λ space switches (electrical) followed by ΛJ×J broadcast units (RF couplers or optical couplers) or space switches. Λ in this example is equal to the total number of ports of the subnet switch, which is equal to the number of nodes per group.

In some examples, the number of nodes per group, A, is equal to the number of paths in the space switch in the subnetwork unit. For example, the space switch in the subnetwork unit may have Λ×Λ input/output ports.

It will be appreciated that examples can be combined and the non-optical examples apply equally to the network electronic-time-division multiplex circuit-switched network.

Further discussion of the network architectures of the fourth and fifth aspect will now be presented.

In some examples, the network is a port-level fully connected network. This is different from comparative examples that are node-level in the sense that in the comparative examples a single transceiver is used to communicate between any node pairs.

In some examples, the network comprises multiple nodes (x, J, Λ) organised in clusters, groups and nodes per groups. In these examples, a cluster contains one or multiple groups, each groups contains one or multiple nodes. The number of clusters in the system is x, the number of groups per cluster is J, and the number of nodes per group is Λ. The number of nodes per group Λ is equal to the number of wavelengths available for the OCS (optical circuit switched) system or the number of paths in the e-TDM (electronic-time-division multiplex) system switch. In these examples, J≤x and/mod x=0.

In some examples, the architecture is a subnet-based architecture, where different subnets connect different sets of nodes. Each subnet connects the same port of all nodes in different cluster pairs (whereas, in comparative examples only group pairs are connected). Each subnet is a ΛJ×ΛJ network device. It may comprise either a combination of ΛJ×Λ broadcast (OCS) or routing (wavelength routing OCS/space-switching e-TDM) elements followed by ΛJ×J broadcast (OCS/e-TDM) or switching (OCS/e-TDM) elements. Comparative examples, such as PULSE, have one Λ×Λ either broadcast or wavelength routing element. In some examples there are a total of bx³ subnets, whereas in comparative examples, such as PULSE, there may be x⁴.

In some examples, port level all-to-all communication is possible through the use of a particular transceiver. Each transmitter and receiver may be connected to a 1×x and x×1 space switch respectively, each ports of each connecting to a different subnetwork. The switch port at transmission side selects the destination cluster to transmit to. The switch port at reception side selects the source cluster to receive from. In comparative examples, only a group in a specific cluster is selected.

In some examples, the transceiver allows wavelength tuneability (across Λ wavelengths) at either/both transmitter and receiver side for OCS. The wavelength selection at either side forces the source destination node per group pairs for each communication. For e-TDM systems this may be performed by selecting the path in the subnet space-switch. The wavelength selection for each source destination pair might be the same or independent depending on the transceiver group used. The selection may be dependent on the choice of the x:1 switch. If the switch is formed by an SOA gated multiplexers a different mapping per transceiver group may be used.

In some examples, each node in the system is equipped with bx transceivers. These transceivers are grouped into x transceiver groups each having b transceivers. Each transceiver may be connected to a different set of sub-nets, to communicate to the same transceiver of all nodes. The number of transceiver groups x may be equal to the number of communication groups, such that each node can transmit information to all communication groups at same time (useful for HPC applications). Each transceiver in a transceiver group may share the same tuneable laser (if OCS with tuneable tx) and same control (for OCS and e-TDM). All transceivers of the same transceiver group may transmit to the same node.

In some examples, each transceiver group can act independently, and transmit and receive from any node at any time step. This means that the same node can transmit at the same time to multiple nodes using different transceivers. Each node can transmit at the same time to either: nodes of different clusters and group, nodes of different clusters and same group, nodes of same cluster different groups, same cluster same group different nodes, same cluster same group same node using full-capacity. Meaning that there is unrestricted communication between node pairs, and increased bandwidth connectivity between node pairs or node sets is possible by using multiple transceivers in parallel.

Thus, the present approaches increase network resilience as there is no single point of failure. Whenever a network component (trx/subnet) fails there may be additional paths available, and the network is reconfigured such that the faulty resources are not used.

A contrasting with a comparative example, PULSE, will now be shown in comparative tables 1 and 2 below:

| | | | | | Transceiver | |
|---|---|---|---|---|---|---|
| | Subnet | | | Transceiver | communicates | Subnet |
| | size | Subnet Type | Tunability | Switch | to | Connects |
| Present | ΛJ × ΛJ | Star Coupler, | Tunable Tx − | 1 × x − x × 1 | ΛJx Nodes | Cluster |
| techniques | | Star Coupler + | Fixed Rx, | | | pairs |
| | | Filter + Star | Fixed Tx − | | | |
| | | Coupler, | Tunable | | | |
| | | ΛWGR + Star | RX, | | | |
| | | Coupler, Star | Tunable Tx + | | | |
| | | Coupler + | Tunable | | | |
| | | Filter + Space | Rx | | | |
| | | Switch, | | | | |
| | | ΛWGR + Space | | | | |
| | | Switch | | | | |
| PULSE | Λ × Λ | Star Coupler | Tanable Tx + | 1 × x − | ΛJ Nodes | Group |
| | | | Tunable | x × 1, | | pairs |
| | | | Rx | 1 × p − p × 1 | | |

| | | Max Number of | | Number of paths | | | |
|---|---|---|---|---|---|---|---|
| | | transceivers used | Connectivity | between source | | Number of | |
| | | between any | limitation | destination pair | | clusters, | #Transceiver |
| | Wavelength Selection | node pairs | per node | (resiliency) | Group size | groups | groups |
| Present | Side depends on | bx | None | bx | Λ | x, J | x |
| techniques | configuration, selects | | | | | | |
| | node-pair | | | | | | |
| | communication. In the | | | | | | |
| | simplest case with | | | | | | |
| | fixed rx selects | | | | | | |
| | destination node | | | | | | |
| | number in group | | | | | | |
| PULSE | Selected at both sides, | 1 | 1 of Λx | 1 | Λ | p, x | x |
| | dynamic. Selects the | | | | | | |
| | source destination | | | | | | |
| | node numbers in a | | | | | | |
| | group pair. | | | | | | |

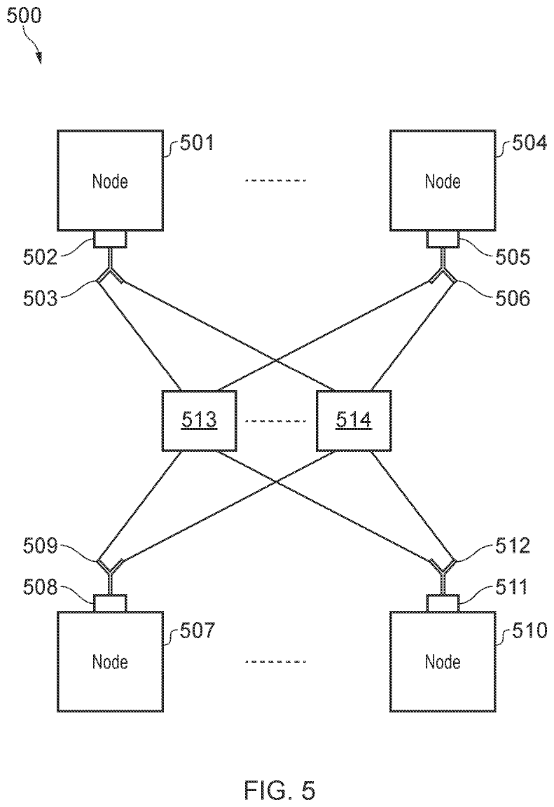

FIG. 5 schematically illustrates an example network 500 according to the present techniques. Network 500 may be an optical circuit-switched network, or alternatively an electronic-time-division multiplex circuit-switched network. Network 500 comprises a plurality of nodes 501, 504, 507, 510. The nodes may perform the present techniques described herein, for example method 200. Each node is configured to implement time-division multiplexing such that each node, at a given time, belongs to a transmitting group or a receiving group. It will be appreciated that the transmitting and receiving groups may change over time, and the node can in general transmit and receive. In FIG. 5, nodes 501 and 504 may be considered a transmitting group, and nodes 507 and 510 may be considered a receiving group.

Each node may comprise one or more transceivers 502, 505, 508, 511. In some examples, each node comprises multiple transceivers. These transceivers may in some examples be optical transceivers. The network also comprises a plurality of one-to-many switches 503, 506, and a plurality of many-to-one switches 509, 512. Again, it will be appreciated that this is defined by the direction of the connection between nodes of the transmitting and receiving groups.

The transceivers may be integral or non-integral of the nodes, or connected circuitry. Each transceiver of each of the transmitting group of nodes (i.e. 502 and 505) is connected to a one-to-many switch (i.e. 503 and 506). Each transceiver of each of the receiving group of nodes (i.e. 507 and 510) is connected to a many-to-one switch (i.e. 509 and 512).

Network 500 also comprises a plurality of subnetwork units 513, 514 (also referred to as subnets). The subnetwork units may be optical subnetwork units, and/or may be coupling units or routing units. As shown in FIG. 5, each port of each of the one-to-many switches (503, 506) and the many-to-one switches (509, 512) connects to a different subnetwork unit 513, 514. It will be appreciated that FIG. 5 shows an example configuration, and that the number of nodes, transceivers, switches, and subnetwork units may vary.

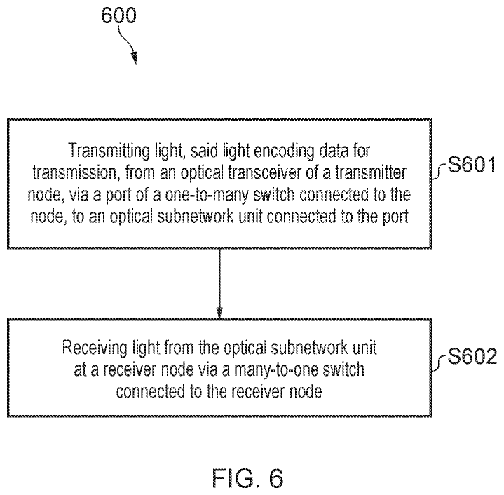

FIG. 6 illustrates a method 600 for communication in a network, for example network 500. In this, the network is an optical circuit-switched network.

At S601, light encoding data for transmission is transmitted from an optical transceiver of a transmitter node, via a port of a one-to-many switch connected to the node, to an optical subnetwork unit connected to the port. With reference to FIG. 5, light may be transmitted from an optical transceiver 502 of node 501, via a port of a one-to-many switch 503 connected to the node 501, to an optical subnetwork unit 513 connected to the port.

At S602, light is received from the optical subnetwork unit at a receiver node via a many-to-one switch connected to the receiver node. Again with reference to FIG. 5, light may be received from the optical subnetwork unit 513 at a receiver node 510 via a many-to-one switch 512 connected to the receiver node 510. Thus, in this way, light may be communicated through the network from a transmitter node to a receiver node.

It will be appreciated that a version of method 600 may be performed in the electronic-time-division multiplex architecture described herein.

In some examples, there is provided a method for communication in an electronic-time-division multiplex architecture network, the method comprising: transmitting data, from a transceiver of a transmitter node, via a port of a one-to-many switch connected to the node, to a subnetwork unit connected to the port; and receiving the data from the subnetwork unit at a receiver node via a many-to-one switch connected to the receiver node.

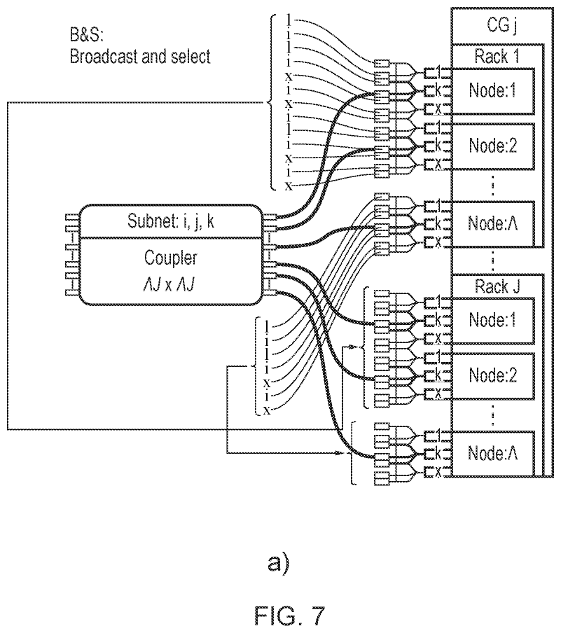

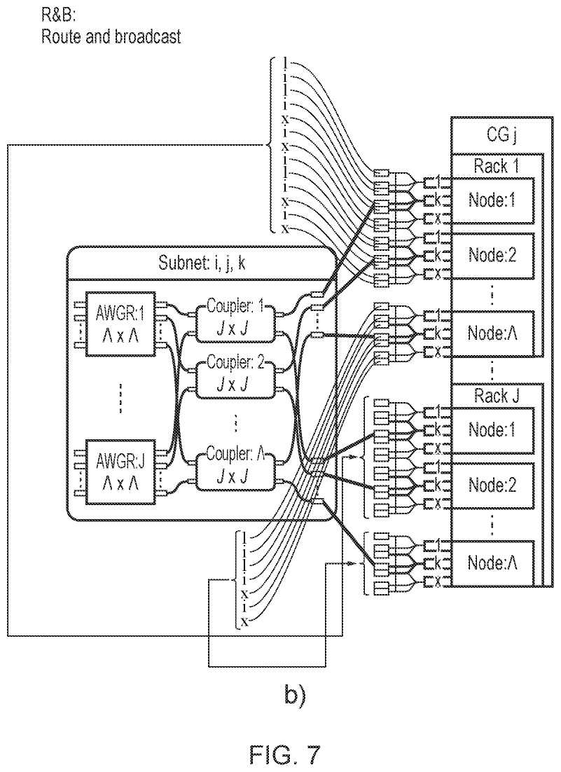

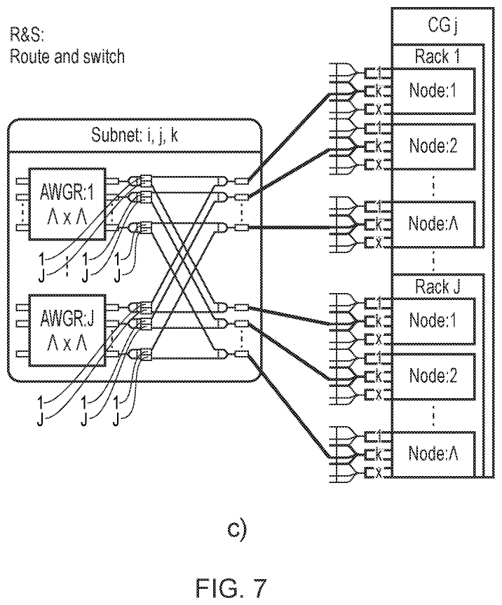

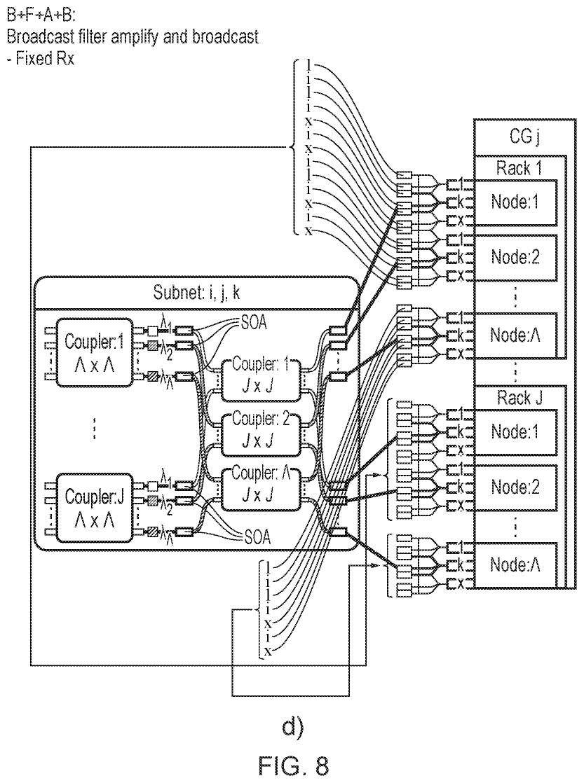

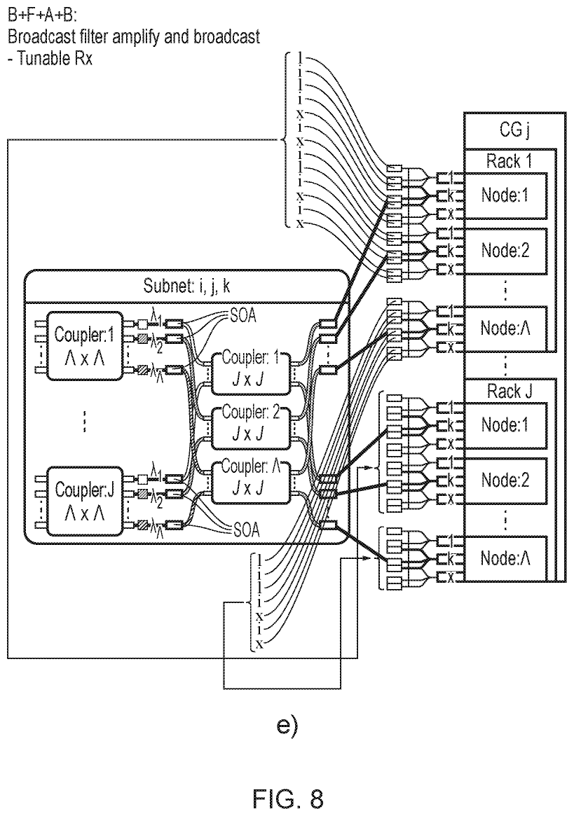

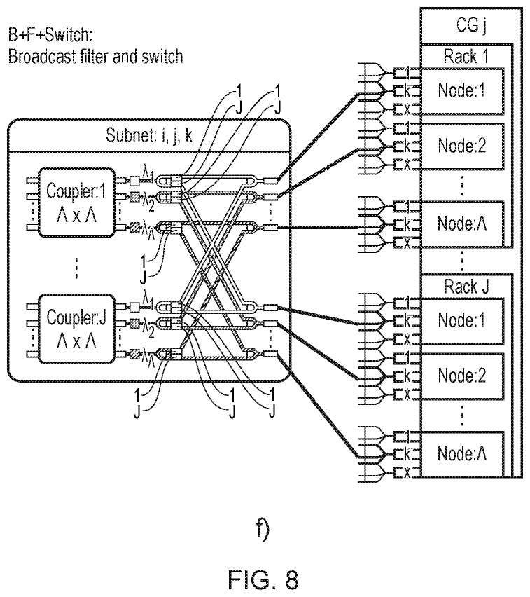

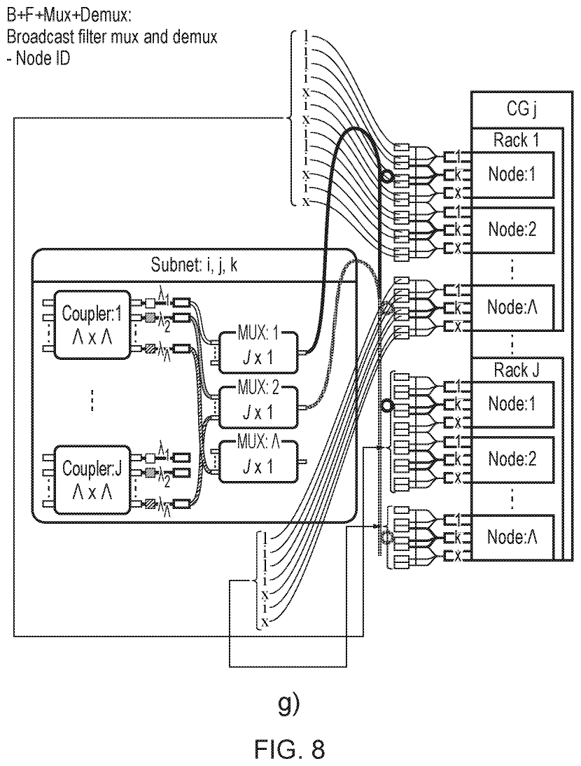

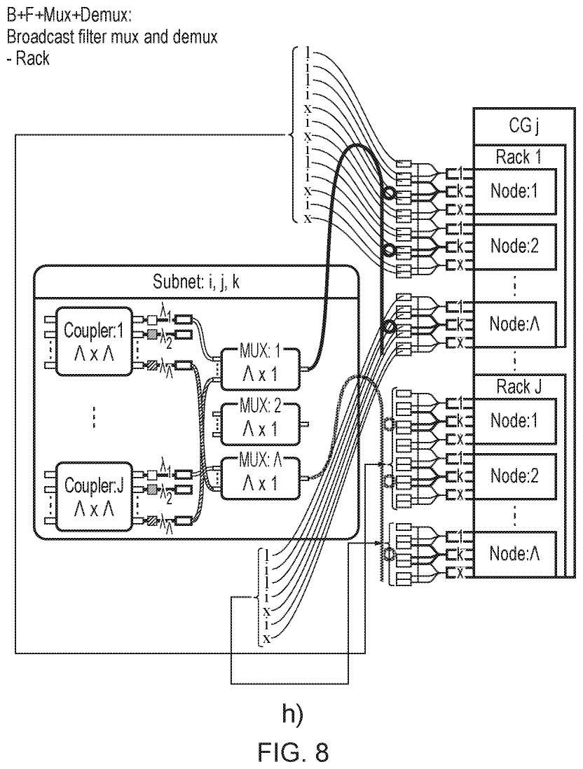

FIGS. 7 and 8 illustrate example subnetwork unit types.

FIG. 7a depicts a broadcast and select (B&S) type. The passive subnetwork, shown in FIG. 7a, comprises an N×N star-coupler, connecting the i^{th} transmitter and receiver of two different communication groups. The number of ports in this subnetwork, N, may be different than the number of wavelengths Λ (scaling independent of wavelength channel map). The number of ports N may be up to Λx. The greater number of ports of a star-coupler may lead to higher loss. The system could be implemented using wavelength tunability at transmitter and/or receiver side. This example may use either a tunable receiver/tunable transmitter or both. In some examples, the transmitter is tuneable and the receiver is fixed, which may be preferred in certain use cases. A star coupler connects all nodes between cluster pairs.

FIG. 7b depicts a route and broadcast (R&B) type. The Route and Broadcast architecture is an N×N port subnetwork comprising two main components: arrayed waveguide gratings (AWGRs) and star-couplers. At the input stage, ΛJ×Λ AWGRs, each route the information coming from the i^{th} port of each individual rack. All the l^{th} output ports of every AWGR are then connected to a ΛJ×J star-coupler. The j^{th} output port of the k^{th} star-coupler is connected to the i^{th} port of the k^{th} device in j^{th} rack. As the maximum subnetwork size is N=Λx, this network requires xΛ×Λ AWGRs and Λx×x star-couplers. In the case where J=1, the subnetwork may be a single AWGR. The wavelength routing followed by the broadcast requires wavelength tunability both at transmitter and receiver side. This example may use tunability at both transmitter and receiver. ΛJ×Λ AWGRs followed by ΛJ×J star couplers connected between the same port numbers of each AWGR. All port 1 of the J AWGRs are connected in the star coupler 1.

FIG. 7c depicts a route and switch (R&S) type. In the R&S example, each output port of any AWGR is followed by a gated 1×J splitter for a total of N splitters. The output ports of the SOAs are then connected to the input ports of an array of NJ×1 combiners. The output of the SOA connected to the kth port of the splitter for the λ^{th} output port of the AWGR routing the information of the j^{th} transmission rack and is connected to the j^{th} port of the combiner connected to the λ^{th} node of the k^{th} receiving rack. This effectively creates an array of ΛJ×J spatial switches. In this type of system a single path at both combiners will actually receive information, therefore tuneability at receiver is not needed. Transmitter tuneability is required for routing through the AWGR. This example may use tunability at both transmitter and receiver. ΛJ×Λ AWGRs followed by ΛJ×J space switches connected between the same port numbers of each AWGR. All port 1 of the J AWGRs are connected in the space switch 1.

FIG. 8d depicts a broadcast, filter, amplify, and broadcast subnet with a fixed receiver. In this example, the following configuration is used: star coupler+filter+amplification+star coupler, with a tunable transmitter and fixed receiver. ΛJ×Λ Star couplers each followed by ΛJ×Λ filters, such that all ports with same number have the same wavelength. These may be followed by an amplification stage per ports and then by ΛJ×J star couplers connected between all filters with the same wavelength. All port 1 of the J coupler+filters+amplifications are connected in the star coupler 1. This figure shows a configuration with a tunable transmitter and a fixed receiver. In this configuration, ports that have filtered the i^{th} wavelength will be coupled by the i^{th} star coupler.

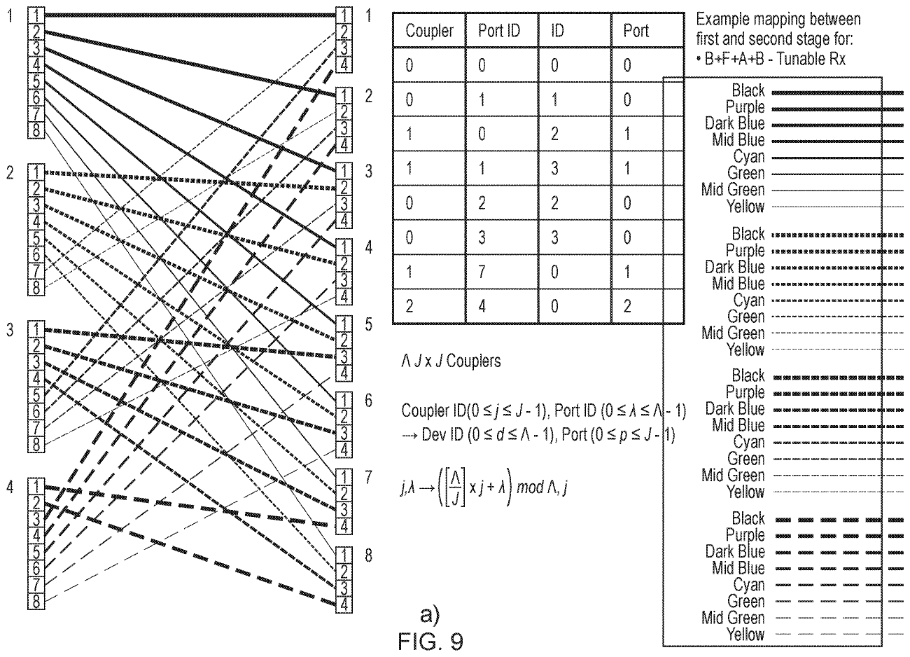

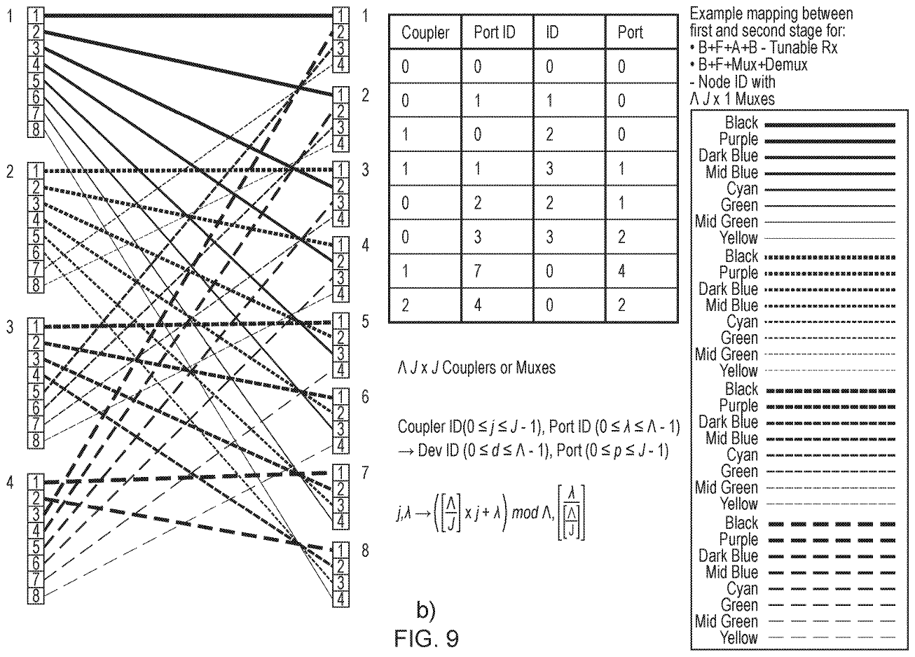

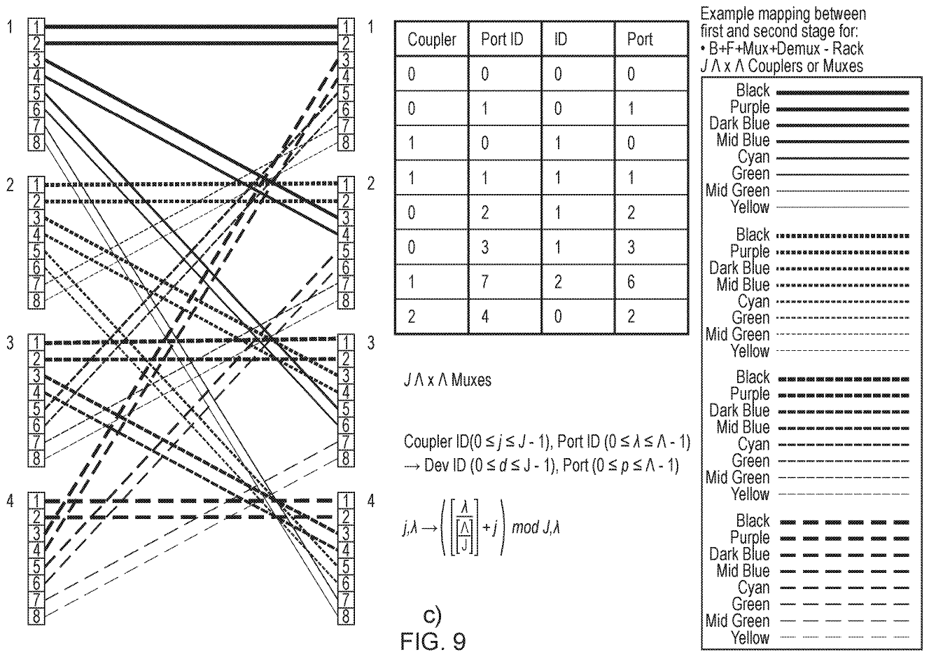

FIG. 8e depicts a broadcast, filter, amplify, and broadcast subnet with a tunable receiver. In this example, the following configuration is used: star coupler+filter+amplification+star coupler, with a tunable transmitter and tunable receiver. ΛJ×Λ Star couplers each followed by ΛJ×Λ filters, such that all ports with same number have the same wavelength. These may be followed by an amplification stage per ports and then by ΛJ×J star couplers connected between all filters with the same wavelength, in a similar manner to the example of FIG. 8d. FIG. 8e shows a configuration with a tunable transmitter and a tunable receiver. In this configuration, subsequent ports of different filters (port 1 filter 0 with port 1 filter 1 and so on, port 1 filter 0 with port 2 filter 1 . . . ) are connected to by ΛJ×J star couplers in a cyclic manner. An example of such connectivity is shown in FIG. 9a and FIG. 9b.

A further realisation of this may be A) using tunability at both sides. B) for the second stage of couplers (after filter and possible amplifiers) the wavelengths instead of being the same (all port 1s of all the J couplers) are connected to different wavelengths in a cyclic way (port/w 1 of coupler 1 with port/w 2 of coupler 2 and so on for the first coupler at second stage, port/w 2 of coupler 1 with port/w3 of coupler 2 and so on for the second coupler of stage 2 and so on). In this way contention may be decreased. An example of such connectivity is shown in FIG. 9a and FIG. 9b.

FIG. 8f depicts a broadcast, filter, and switch subnet. In this example, the configuration is as follows: star coupler+filter+switch, with a tunable transmitter and fixed receiver. ΛJ×Λ star couplers each followed by ΛJ×Λ filters, such that all ports with the same number have the same wavelength. These are followed by ΛJ×J space switches connected between all filters with the same wavelength. All port 1 of the J coupler+filters are connected in the space switch.

FIG. 8g depicts a broadcast, filter, multiplexer, and demultiplexer subnet. In this example, the following configuration is used: star coupler+filter+multiplexer+demultiplexer, with a tunable transmitter and high bandwidth receiver. JΛ×Λ star couplers each followed by ΛJ×Λ filters, such that all ports with the same number have the same wavelength. Subsequent ports of different filters (port 0 filter 0 with port 1 filter 1 and so on, port 1 filter 0 with port 2 filter 1 . . . ) are connected to ΛJ×1 multiplexer. Each of these is followed by a tunable add and drop Λ1×J filters. Each of these extract a wavelength per port. These components can either be at subnet or edge. Each of the ports connect devices with the same node ID of different racks of the same communication group. FIG. 8g shows the filters at the edge. Example connectivity for this subnet is shown in 9b.

8 h depicts a broadcast, filter, multiplexer, and demultiplexer subnet. In this example, the following configuration is used: star coupler+filter+multiplexer+demultiplexer, with a tunable transmitter and high bandwidth receiver. ΛJ×Λ star couplers each followed by ΛJ×Λ filters, such that all ports with the same number have the same wavelength. Subsequent ports of different filters (port 0 filter 0 with port 1 filter 1 and so on, port 1 filter 0 with port 2 filter 1 . . . ) are connected to ΛJ×1 multiplexer. Each of these is followed by a tunable add and drop J1×Λ filters. Each of these extract a wavelength per port. These components can either be at subnet or edge. Each of the ports connect devices with different node ID of the same rack of the same communication group. FIG. 8h shows the filters at the edge. Example connectivity for this subnet is shown in 9c.

For the examples of 8g and 8h, alternatively, the second stage may be formed by J Λ: 1 multiplexers. Each multiplexer may choose subsequent nodes of each device in a cyclic manner. In this way the add and drop cascade of filter is performed for same switch port of all node IDs with the same rack and same communication group.

Thus, example subnet connectivity may be as follows:

Broadcast and select (exemplified in FIG. 7a): each subnet may be formed by a ΛJ×ΛJ star coupler. Thus, in some examples, one or more optical subnetwork units is configured to perform broadcast and select, and wherein the one or more optical subnetwork units comprises a ΛJ×ΛJ star coupler.

Route and broadcast (exemplified in FIG. 7b): each subnet may be formed by ΛJ×Λ AWGRs connected to an array of ΛJ×J star couplers, such that the i^{th} port of the j^{th} AWGR is connected to the j^{th} port of the i^{th} star coupler. Thus, in some examples, one or more optical subnetwork units is configured to perform route and broadcast, and wherein the one or more optical subnetwork units comprises JΛ×Λ AWGRs connected to an array of ΛJ×J star couplers, such that the i^{th} port of the j^{th} AWGR is connected to the j^{th} port of the i^{th} star coupler.

Route and switch (exemplified in FIG. 7c): each subnet is composed by an array of JΛ×Λ AWGRs and an array of ΛJ×J space switches, connected such that i^{th} port of the j^{th} AWGR is connected to the j^{th} port of the i^{th} space switch. The order of connectivity can either be AWGR array followed by switch array or switch array followed by AWGR array. Thus, in some examples, one or more optical subnetwork units is configured to perform route and switch, and wherein the one or more optical subnetwork units comprises ΛJ×Λ AWGRs and an array of ΛJ×J space switches, connected such that i^{th} port of the j^{th} AWGR is connected to the j^{th} port of the i^{th} space switch.

Broadcast filter amplify and broadcast (exemplified in FIG. 8d): each subnet is composed by an array of JΛ×Λ star couplers followed by an array of ΛJ×Λ optical filter arrays configured such that the i^{th} port of the j^{th} star coupler is connected to the i^{th} port of the j^{th} filter, which retrieve the i^{th} channel for all the J filter arrays. After the array of filter array, there may optionally be an amplification stage at each port through use of JΛ×Λ semiconductor optical amplifier arrays. After the array of filter arrays and optional amplification there is an array of ΛJ×J star couplers. This can either be connected orthogonally or cyclically. Orthogonally: the i^{th} port of the j^{th} array (filter or SOA) is connected to the j^{th} port of the i^{th} star coupler. Cyclically: Each port of each star coupler is connected to different ports of different arrays. An example of such connectivity is shown in FIG. 9a and FIG. 9b. Thus, in some examples, one or more optical subnetwork units is configured to perform broadcast, filter, amplify and broadcast, and wherein the one or more optical subnetwork units comprises JΛ×Λ star couplers followed by JΛ×Λ optical filter arrays configured such that the i^{th} port of the j^{th} star coupler is connected to the i^{th} port of the j^{th} filter, followed by an array of ΛJ×J star couplers.

Broadcast and switch (exemplified in FIG. 8f): each subnet comprises two stages:
1) an array of JΛ×Λ Star couplers followed by an array of JΛ×Λ optical filters configured such that the i^{th} port of the j^{th} star coupler is connected to the i^{th} port of the j^{th} filter, which retrieves the i^{th} channel for all the J filter arrays. After the array of filters, there may optionally be an amplification stage at each port through the use of JΛ×Λ semiconductor optical amplifier arrays.
2) an array of ΛJ×J space switches.
The i^{th} port of the j^{th} array (filter or SOA) is connected to the j^{th} port of the i^{th} space switch. The order of connectivity can either be star+coupler+filter (+optional SOA) array followed by switch array or switch array followed by star+coupler+filter (+optional SOA) array. Thus, in some examples, one or more optical subnetwork units is configured to perform broadcast and switch, and wherein the one or more optical subnetwork units comprises JΛ×Λ star couplers followed by an array of JΛ×Λ optical filters configured such that the i^{th} port of the j^{th} star coupler is connected to the i^{th} port of the j^{th} filter, followed by ΛJ×J space switches.

Broadcast filter mux and demux (exemplified in FIGS. 8g and 8h): each subnet is composed by an array of JΛ×Λ star couplers followed by an array of ΛJ×Λ optical filters configured such that the i^{th} port of the j^{th} star coupler is connected to the i^{th} port of the j^{th} filter, which retrieves the i^{th} channel for all the J filter arrays. After the array of filter arrays there may optionally be an amplification stage at each port through the use of JΛ×Λ semiconductor optical amplifier arrays. This may then be either followed by:
1) ΛJ×1 muxes array connected in a cyclical fashion to the previous stage (example connectivity shown in FIG. 9b). Each of the Λ filters is connected to an array of Λ 1×J tunable demultiplexers formed by a series of cascaded J add- and drop filters, such that the j^{th} mux is connected to the j^{th} demux. The demux stage can either be within the subnet or at the edge of the network.
or 2) ΛJ×1 muxes array connected in a cyclical fashion to the previous stage (example connectivity shown in FIG. 9c). Each of the J filters is connected to an array of J 1×Λ tunable demultiplexers formed by a series of cascaded J add- and drop filters, such that the j^{th} mux is connected to the j^{th} demux. The demux stage can either be within the subnet or at the edge of the network.
Thus, in some examples, one or more optical subnetwork units is configured to perform broadcast, filter, multiplex, and demultiplex, and wherein the one or more optical subnetwork units comprises JΛ×Λ star couplers followed by an array of JΛ×Λ optical filters configured such that the i^{th} port of the j^{th} star coupler is connected to the i^{th} port of the j^{th} filter, followed by either: a ΛJ×1 multiplexer array, each connected to an array of J1×Λ tunable demultiplexers formed by a series of cascaded J add—and drop filters, such that the j^{th} multiplexer is connected to the j^{th} demultuiplexer; or a JΛ×1 multiplexer array, each connected to an array of J1×Λ tunable demultiplexers formed by a series of cascaded J add—and drop filters, such that the j^{th} multiplexer is connected to the j^{th} demultiplexer.

It will be appreciated that one or more of the optical subnetwork units present in the network may be configured to perform the above-described techniques, and subnetwork units performing different techniques may be combined in the same network.

Further example subnetwork unit realisations are as follows:

i) Either tunable receiver/tuneable transmitter or both. In some examples, the transmitter is tuneable and the receiver is fixed, which may be preferred in certain use cases. Star coupler connects all nodes between cluster pairs.

ii) Tunability at both transmitter and receiver. JΛ×Λ AWGRs followed by ΛJ×J star couplers connected between the same port numbers of each AWGR. All port 1 of the J AWGRs are connected in the star coupler 1.

iii) Tunability at both transmitter and receiver. JΛ×Λ AWGRs followed by ΛJ×J space switches connected between the same port numbers of each AWGR. All port 1 of the J AWGRs are connected in the space switch 1.

For the present subnet examples, after the filtering stage an amplification stage using SOAs may be present.

The system before any port of the many to one switches may have either: no filter, fixed filter, or a tunable filter. The filter-less system may be used in: A) in case of coherent detection with when low amplification at switching stage is needed; B) In case filtering has already been performed in the Subnet, like the fixed receiver B+F+A+B system. Fixed filter: may be used for both coherent and direct detection communication. It may be used in case the system requires fixed reception. The filter may be chosen such that it will be able to retrieve a single wavelength from the plurality. The filter selection may be made such that no two filters will retrieve same wavelength for the same switch port of all nodes in a rack. The wavelength selection for each switch port in a single node (and transceiver) can either be the same or different. This selection may be important for the choice of the many-to-one switch technology (different wavelength could allow the use of SOA gated AWG as a switch). Tunable filter: may be used for both coherent and direct detection communication. It may be used in case the system requires tunable receiver (direct detection) and the signal requires edge amplification in coherent systems.

In some examples, the xgs are placed before the many to one switch elements.

Tunable filters can be ad and drop filters connecting devices such that in the case of the Star coupler+filter+multiplexer+demultiplexer subnet (f above).

### Worked Example

The present techniques will now be described with reference to a worked example. Aspects of the worked example have been identified by the present inventors as increasing the efficiency of MPI collective operation performance and reducing collective operation completion time. As part of this worked example, a network architecture is described. It will be appreciated that the present techniques may be and in some cases are implemented in this network architecture. In some examples, performance of the present techniques in the below described architecture may further increase the efficiency of MPI operation performance. Indeed, the present inventors have identified that the present techniques realise at least the following advantages over comparative examples that do not use the present techniques:
1. High-capacity communication between node pairs (for example>12.8 Tbps), making the network architecture suitable for HPC and DDL application requirements.
2. High scalability (for example>4096 nodes). Capable of handling increasingly complex workloads.
3. Nanosecond level circuit reconfiguration through wavelength switching and B&S (broadcast and select). This allows each node to communicate to any other node with virtually no communication degree constraints; allows using collective operations with logical graphs with significantly lower diameters without sacrificing bandwidth; allows the proposed architecture to handle fast-changing circuits which are required for DCN traffic.
4. Port-level all-to-all connectivity and re-arrangeable or strictly non-blocking communication. Any transceiver can transmit/receive information to/from any node. Communication blocking probability depends on the selection of the sub-network only.
5. Fully passive interconnect system. Removing complexity from the core of the network and moving it to the edge.
6. Unrestricted multi-node communication and reliability, without any single point of failure. Every node can talk to every other node using multiple possible paths, and any failure for transceivers/network components still allows all-to-all communication just at a slightly decreased capacity.

### Example Network Architecture

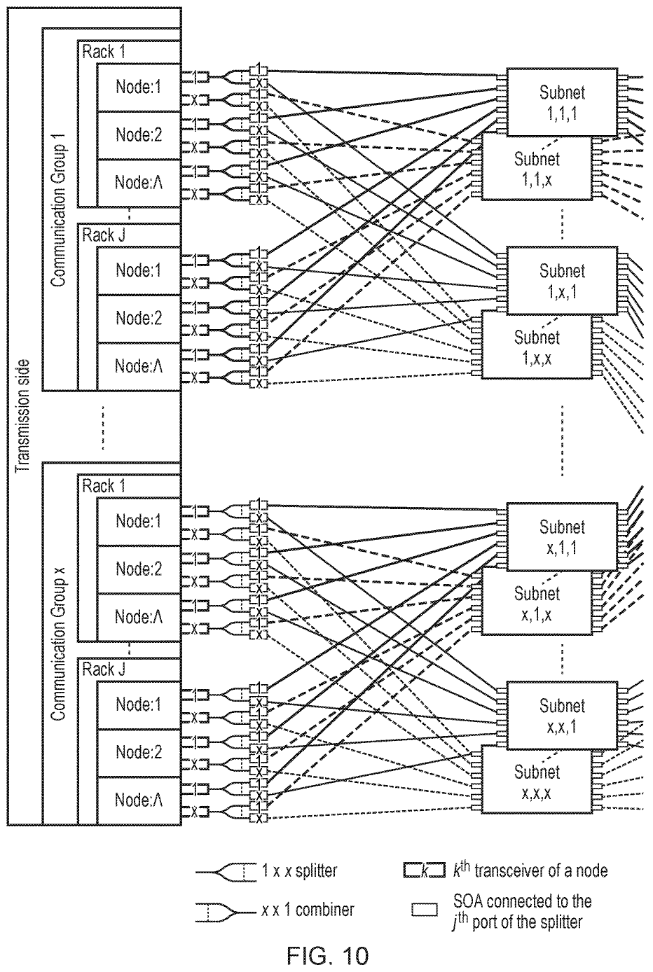

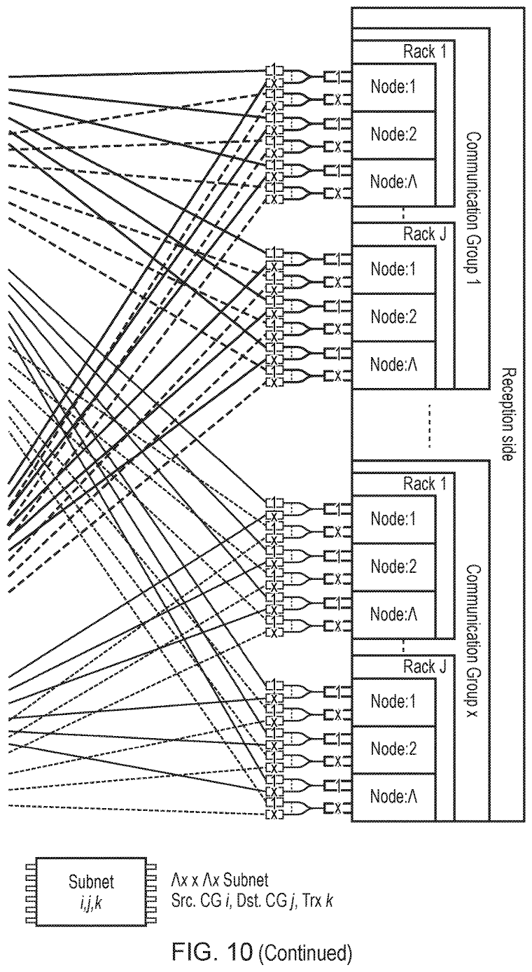

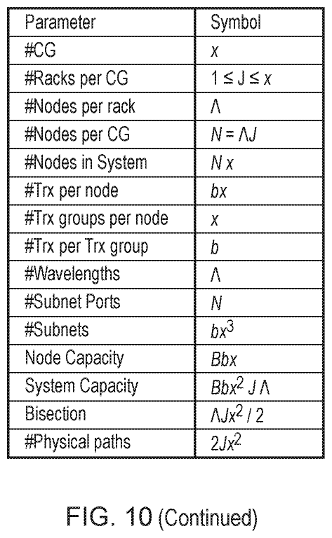

In some examples, the present techniques are performed in an electrically packet switched network. However, in other examples, the present techniques are performed in an optical circuit switched, OCS, network. A particular example of which will now be discussed with reference to FIG. 10. It will be appreciated that any combination of features from the example architecture may be combined, and that features may be omitted.

In this example, the network architecture is a switch-less OCS architecture that supports full-bisection bandwidth and high-capacity communication between node pairs, thereby providing fast reconfiguration time (in the order of nanoseconds) and high scalability. The network architecture realises port-level all-to-all connectivity allowing unrestricted multi-node communication and reliability in respect of network component failure. Thus, this example architecture is optimal for HPC and DDL operations where high bandwidth communication between pairs of nodes is required. Further, the nanosecond circuit reconfiguration time and all-to-all connectivity allows each node to communicate with almost no communication degree constraint.

As shown in FIG. 10, the network architecture comprises parallel subnets arranged in communication groups (also referred to as clusters) and transceivers (or transmitters and receivers). In this example, there are x communication groups CG (or clusters), where each communication group contains J racks (also referred to herein as groups), and the maximum number of racks per communication group is J=x. Each rack contains Λ devices or nodes, where Λ is also the total number of wavelength channels available. Hence, the maximum number of nodes in one communication group is N=Λx. Each node is equipped with x transceiver groups, each containing b transceivers sharing the same light source. In the example of FIG. 10, b=1. Each transceiver is connected to a 1:x splitter, creating x possible paths per transceiver. Each path is selected by activating the SOA (semiconductor optical amplifier) attached to each port of the 1:x splitter and connected to a different sub-net and therefore, a different communication group. In this way, each transceiver is able to communicate to every communication group. Each receiver (or transceiver) is connected to a x:1 combiner, so that each receiver can receive information from every communication group. Under the proposed network configuration, the i^{th} transmitter of any node can send information to the i^{th} receiver of every node, enabling all-to-all transceiver-wise communication. In this example, a total of bx³ sub-nets is required by the topology, i.e. a sub-net for a communication group pair per transceiver.

As shown in the right-hand table of FIG. 10, the example architecture scales up to Λx² nodes, providing a total capacity of bBΛx², where B is the effective line-rate of each transceiver. The bisection bandwidth is ΛJx³/2, and the total number of physical links required is 2Jx², as paths can be grouped by racks and source-destination communication groups. Source-destination selection and circuit reconfiguration is performed through path/transceiver, wavelength and time-slot mapping.

There are a number of example choices for the subnets: (i) a star coupler with N ports (Broadcast and Select, B&S), (ii) J parallel Λ×Λ arrayed waveguide gratings, AWGRs, followed by Δ parallel J×J star couplers mixing information between same ports of each AWGRs (Route and Broadcast, R&B) or (iii) the same AWGRs followed by SOA based J×J crossbars switch (Route and Switch, R&S). Other example choices include J arrays of A fixed filters (single wavelength) or amplifiers (SOA or others) or Λ J×1 WDM multiplexer followed by Λ 1×J tunable demultiplexing filter (each port removes one wavelength chosen actively).

Each node in the example architecture may have a coordinate defined by a communication group, rack number in the communication group, and node number in the rack (or cluster, group number, and node number), as discussed in greater detail herein. For example, each node may be identified based on (communication group, rack number, node number).

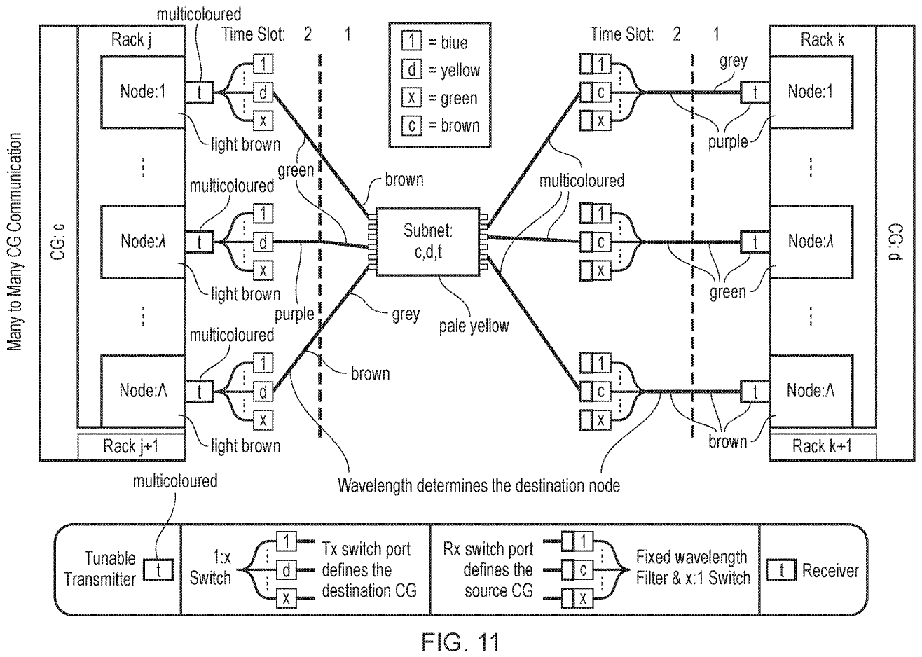

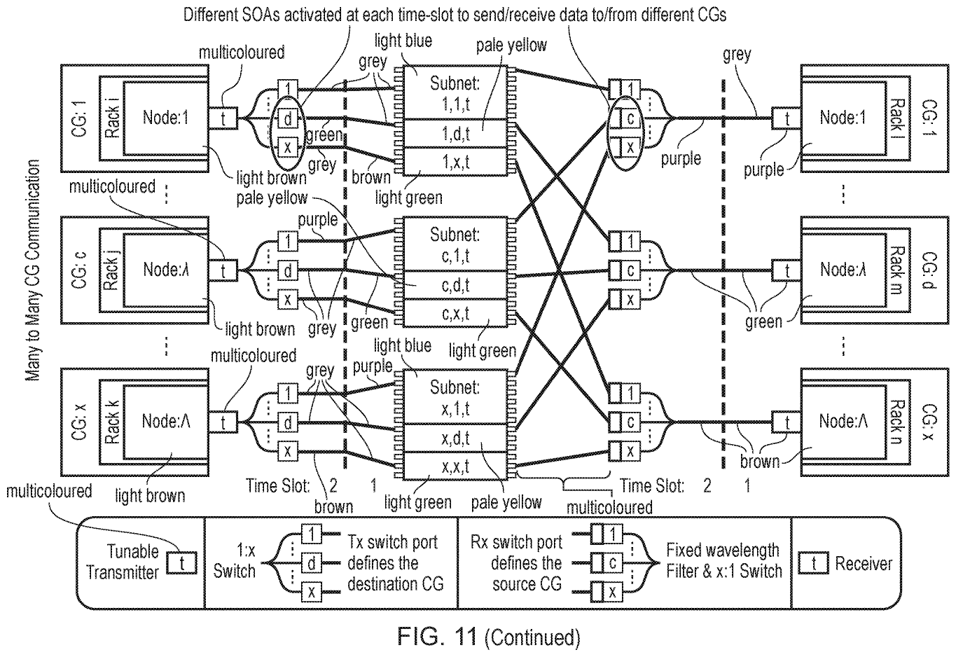

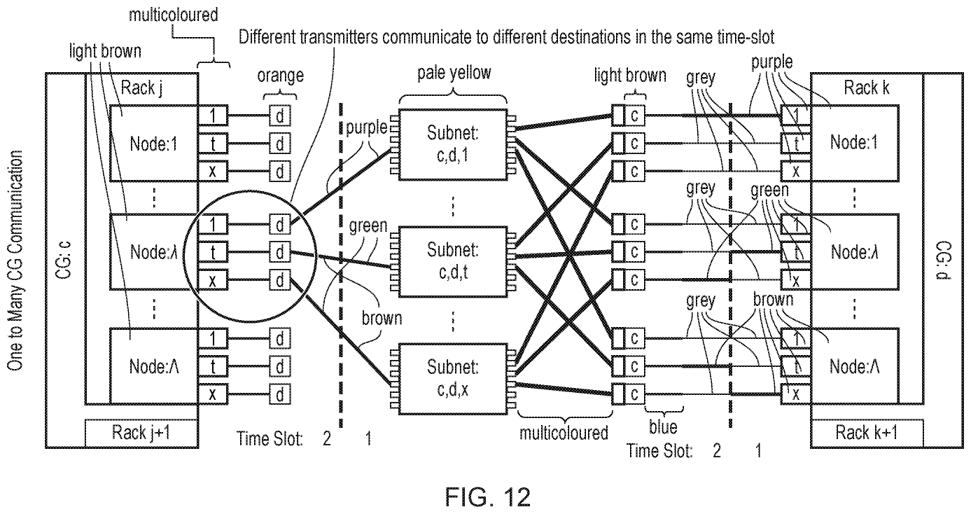

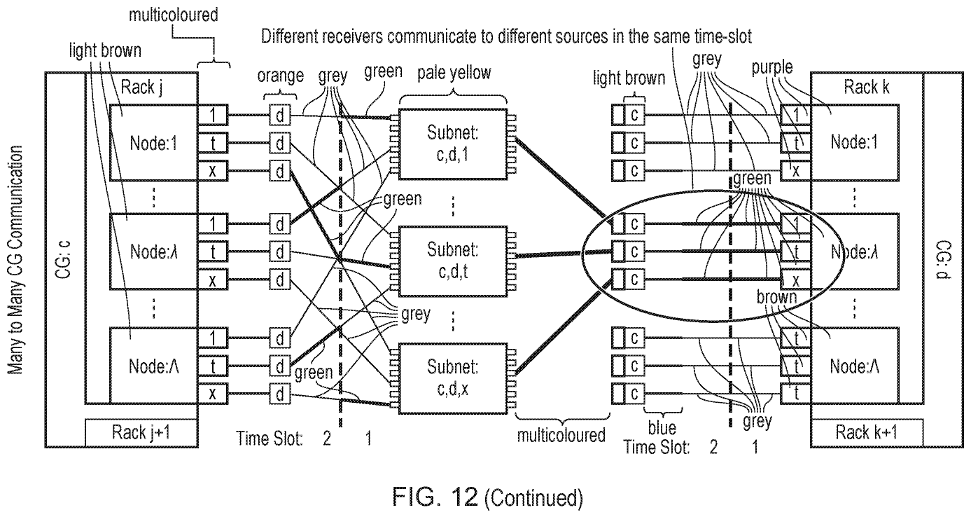

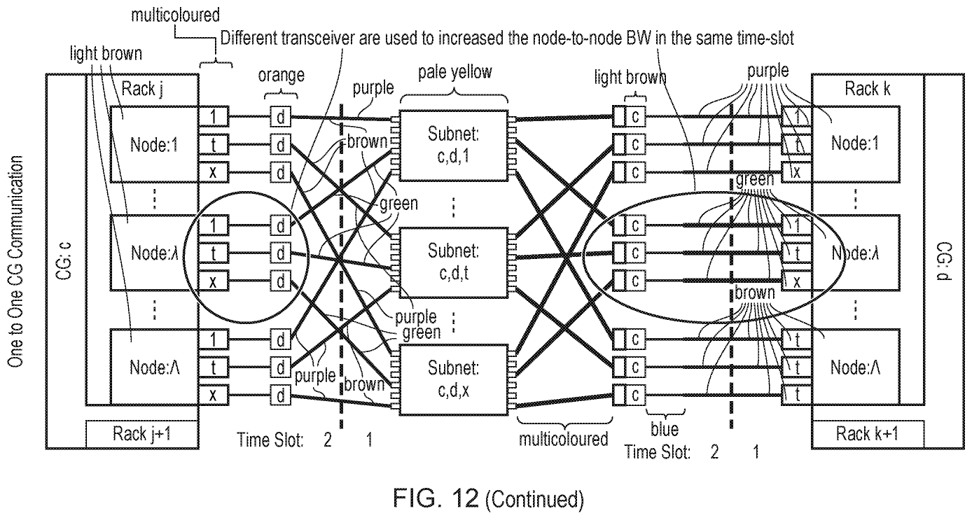

FIGS. 11 and 12 show how the example architecture handles different communication patterns. The example architecture shown in these figures is a fixed receiver Broadcast & Select (B&S), while it will be appreciated that other techniques may be implemented instead.

In FIG. 11 the many-to-many communication pattern in multiple time-slots across multiple sources and destinations within a) single source-destination communication group pair and b) multiple communication groups are shown. For FIG. 11.a) communication between multiple source nodes 1, λ, Λ, of rack j and communication group c and destination nodes 1, γ, Λ of rack k and communication group d by using the t^{th} transceiver. At the transmission side each node has a tunable transmitter followed by a 1:x space switch (implemented by an SOA gated splitter), whereas at the reception side each receiver is preceded by a filtered (single wavelength) x:1 switch (SOA gated coupler), making it a fixed receiver.

Each node in a rack receives at different wavelengths represented in both FIGS. 11 and 12 by receiving node, receiver and filter colour. Between the communication group pairs (c-d) for the t^{th} transceiver exists the single subnet: c; d; t which allows communication between all transmitters t of all source nodes in communication group c and all destination nodes of communication group d. To perform the communication and transmit through the correct subnet the correct port of the switches need to be selected at both the transmission and reception side. At transmission, the switch port corresponds to the destination communication group (port d is used to communicate to the d^{th} communication group) and at reception the source destination group. For both of FIGS. 11 and 12, the colour of the transmission switch port and subnet matches the one of the destinations communication group, and similarly, the colour of the receiving switch port matches the one of the source communication groups which the ports receive from.

At each Time Slot each nodes set its destination by selecting its receiving wavelength, as shown at the transmitting side of FIG. 11.a) where transmitting node (c, j, λ) sends info to node (d, k, γ) and (d, k, 1) by choosing wavelength γ and 1 for time slots 1 and 2 respectively. In each subnet, due to the broadcast principle, each active wavelength is available at each output port (represented by the rainbow colour in FIGS. 11 and 12), the correct wavelength for each destination is recovered by the filter before each port of the 1:x switch. For both time slots as the communication group pair of the source and destination nodes is constant, the ports d and c of the transmission and reception side switches respectively are selected. In a similar fashion, node (d, k, γ) receives from nodes (c, j, λ) and (c, j, 1) in different time slots have been tuned their transmitter at the γ^{th} wavelength. In other words, source destination communication group pairs across different timeslots are kept the same but communication is using different node pairs. The port switches at transmission and reception side are constant too because the source destination communication group pairs is constant.

FIG. 11.b) shows a similar many-to-many pattern between different nodes (1, λ, Λ) for tx and (1, γ, Λ) for rx in different racks (i, j k) for tx and (l, m, n) for rx of different communication groups (1, c, x) for tx and (1, d, x) for rx. Each pair of communication groups is connected by a subnet, accessed through a specific source and destination switch port selection. As in FIG. 11.a) the node selection in a rack is performed through wavelength selection for every time slot whereas different communication groups are accessed by gating different ports of the transmission and reception side switch. In FIG. 11.b), node (c, j, λ) communicates to nodes (d, m, γ) and (1, l, 1) in different time slots by selecting wavelengths 1, γ and gating the ports d, 1 and c, c for transmission and reception side switches respectively in each time slot. Different switch port pairs selection at each time slot lead to different communication group communication allowing effective port-level all-to-all communication with fast reconfiguration.

Further, FIG. 11 may be considered as showing an example of a many to many communication pattern for a network with a star coupler based network using a tunable transmitter and fixed receiver. Source node (c,j,λ) transmits to node (d,k,γ) using transceiver group t, by selecting the wavelength γ for transmission (selecting the destination node number in the receiving cluster), and using port d of the 1×x switch, such that the information is routed to the subnet (c,d,t) which handles communication between the t^{th} transmitters of all nodes of cluster c to the t^{th} receivers of all nodes of cluster d. Destination node (d,k,γ) receives from source node (c,j,λ), by selecting switch port c of its x×1 switch, which allows to receive from transmitters t of all nodes of cluster c, and by recovering its receiving wavelength through filtering. In this figure, multiple paths in different timeslots are shown, within the same cluster and across multiple clusters and groups.

FIG. 12 shows different communication patterns per same time-slot: 12.a) one-to-many, 12.b) many-to-one and 12.c) one to one. For all the communication patterns, FIG. 12 depicts the communication between multiple source nodes (1, λ, Λ) of rack j and communication group c and destination nodes (1, γ, Λ) of rack k and communication group d by using multiple transceivers.

FIG. 12.a) shows the one-to-many communication pattern from source node (c, j, λ) to all the nodes of communication group d rack k. Each transceiver of the source node transmits in the same time slot to different destinations by selecting different wavelengths. If the destinations would have been in different communication groups different transmission and destination switch ports would have been selected for each time slot, similarly to FIG. 12.b).

FIG. 12.b) shows the many-to-one communication pattern, where the destination node (d, k, γ) receives at the same time from multiple destinations by using different transceivers.

FIG. 12.c) shows multiple one-to-one communication patterns between different source pair destinations. In this figure, all transmitters of each source node are used to communicate to all receivers of the same destination node, such that full-capacity communication between node pairs is used at any time slot. It should be noted that in some examples only a subset of transceivers may be used between node pairs depending on the application requirements.

Further, FIG. 12 shows how the network may use multiple transceivers at the same time to transmit/receive data to/from multiple nodes, and that multiple transceivers may be used at the same time between pairs or sets of devices such that bandwidth is increased. This figure uses the same principles of wavelength selection and switch port selection as FIG. 11. While the figure only shows communication between two rack pairs, the principles shown in FIGS. 11 and 12 may be generalised to any node.

The described principles can be used at the same time to adapt the network requests and they are extensively used together for collective operations. It needs to be noted that in both FIGS. 11 and 12 rack selection has not been performed. This is due to the signal between nodes with the same node number of different racks being coupled together, broadcasting the same information to all racks. This may effectively create contention in each subnet, however, the multiple paths between each source-destination pair allow communication to be re-arrangeably non-blocking, and when correctly scheduled up to full bandwidth. In FIGS. 10, 11, and 12 the example architecture is shown with b=1, so the case when a transceiver group is equivalent to one transceiver, although it will be appreciated that b may be greater than 1.

Switching in the example architecture may be achieved by configuring the wavelength/time-slot/path at the end-node transceivers. For wavelength switching, at the transmitter side, wavelength tunable sources (WTS) may be used, for example time-interleaved tunable lasers (for example spanning a wide-range of 122 wavelength channels) with gated SOAs may be used. These have been shown to achieve an effective switching time of <1 ns. On the destination side, the receiver may be either tunable or fixed depending on the subnetwork implantation. If B&S is implemented, the receiver may operate at a fixed wavelength by the use of passive filters. However, wavelength tunability is required when considering subnetworks with wavelength routing functionalities. The tunability can either be implemented by a wavelength filter gated by SOAs or by the use of an additional tunable laser for coherent detection.

For space switching, a B&S filter based on SOA gated couplers and combiners may be used. Using SOA-based gating as a space switching mechanism allows sub-nanosecond path selection. In addition, SOAs are also used for amplification.

Time-division multiplexing may be achieved by using pre-defined timeslots. The synchronisation and Clock Data Recovery (CDR) uses the same principle as known in the art, in particular PULSE and Sirius. The duration of the timeslot may be selected such that the maximum reconfiguration overhead is 5%, leading to a minimum data-transfer slot of 20 ns.

Transceiver node capacity of (B=) 400 Gbps can be achieved using low-energy silicon-organic hybrid (SOH) modulators. Using this example data-rate, the minimum message size that can be transmitted in a timeslot per transceiver is 950B. Such small messages are common in DCN traffic and HPC MPI collective operations at large scale.

Indeed, fast circuit reconfiguration time is desirable for HPC applications, in particular nanosecond circuit reconfiguration times, as it allows for the effective transmission of small message sizes and the used of dynamic collective strategies for MPI operations. In particular, when the circuit reconfiguration time is smaller than the node I/O time (transceiver and computation delay), it will not create any overhead in the transmission time. Since transceiver delays (and thus I/O) delays can be as low as tens of nanoseconds, switching reconfiguration times should follow suit. The present example architecture and techniques achieve such a required switching reconfiguration time. The present example architecture and techniques also provide for better scalability, reduced cost, and reduced power consumption compared to existing known architectures and techniques.

Star-couplers may be used as broadcast technology at both the edge and core of the network. At the edge, they may be used in the form of SOA gated splitters and combiners to create 1:N and N:1 switches. At the core, N:N star-couplers may be used, which have been shown to scale to 1024 ports as an individual component and larger when using a cascaded approach. This approach makes the network passive and cost-effective.

The wavelength routing component in the network core may be an Arrayed Waveguide Grating Router, which has been proven to scale to 100s of ports with low loss.

A combination of these above-described technologies allows the example network to achieve nanosecond circuit reconfiguration times while achieving high node capacity. Thus, in some examples, the present approach provides a more performant network and more efficient performance of MPI operations. These techniques also provide increased scalability, reduced component cost, and reduced power consumption compared to existing network architectures. It will be appreciated that the present techniques, for example method 200, may be combined with this network architecture to further enhance their respective advantages relating to network and operation performance.

### Collective Operations

The network may be controlled by a scheduler. In some examples, the scheduler is configured to handle dynamic traffic. For deterministic operations, the scheduler may interface with distributed hardware to translation information for a network interface card.

The collective operations and MPI operations discussed herein are designed so as to avoid contention and minimise collective operation completion time. Each MPI collective operation follows a set of schedule-less reconfiguration steps based on a) parallel subgroup mapping (nodes performing a subset of collective operations in parallel), b) information and message per nodes mapping at each algorithmic step, c) wavelength and subnet selection, and d) time-slot mapping.

The discussed operations could be implemented on any all-to-all network, for example any port-level all-to-all large-scale network without over-subscription. While various advantages may be achieved using the present operations in known EPS or OCS networks, performance is maximised when the present operations are combined with aspects of the example network architecture. For example, collective operation completion time, cost, and power consumption is reduced.

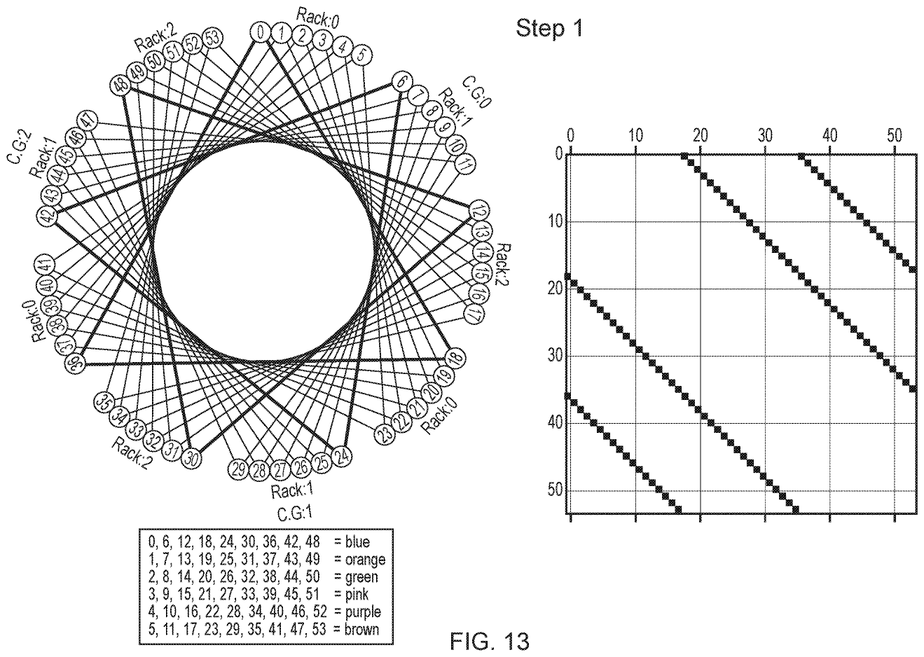

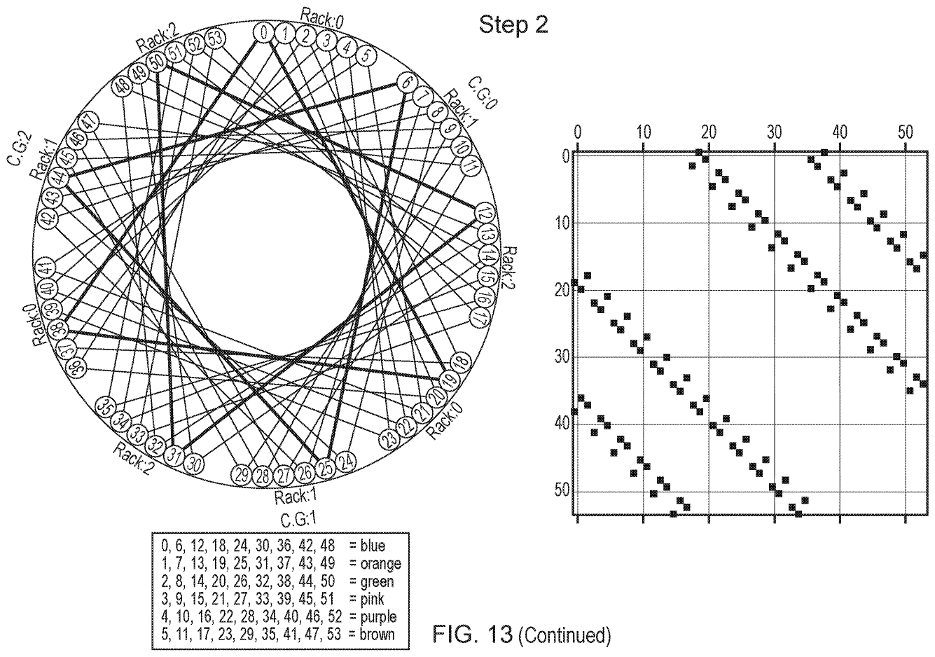

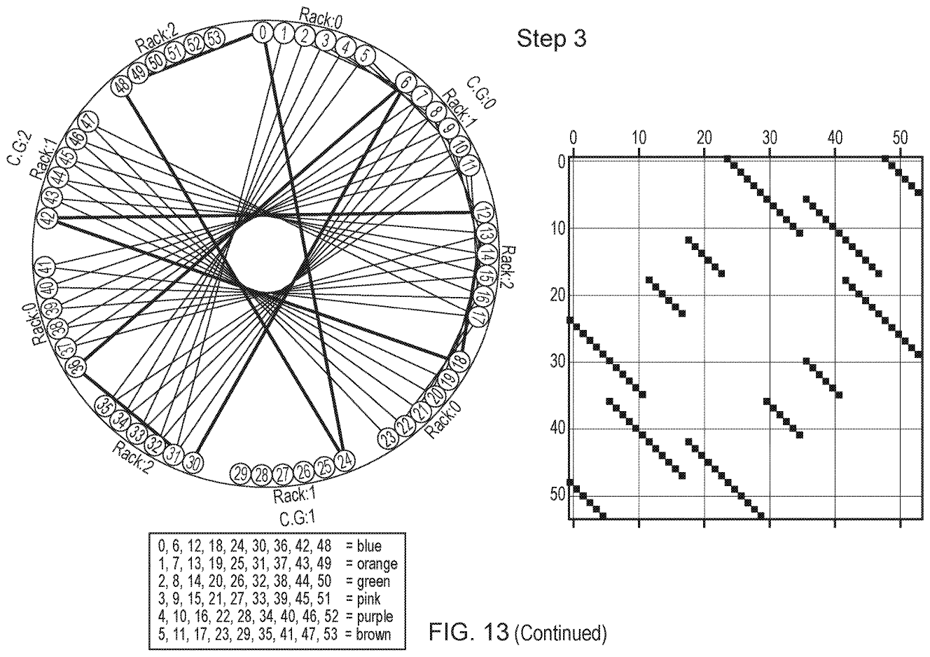

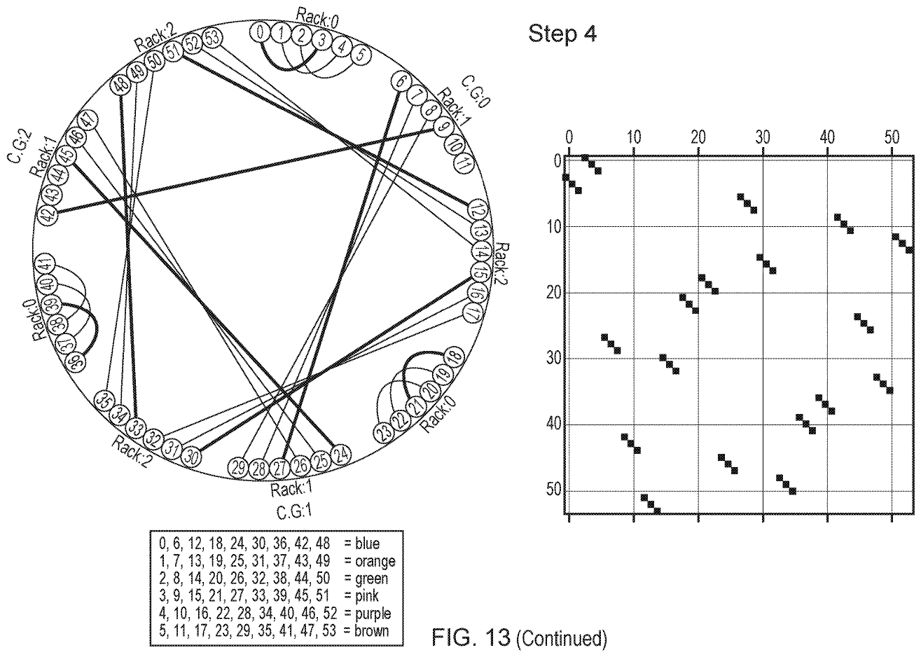

In the following, and as discussed previously, 0≤g≤x−1, 0≤j≤J−1, and 0≤λ≤Λ−1 correspond to the local communication group, rack and device number (represented by colour in FIG. 13) (or the cluster number, group number in the cluster, and node number in the group). The example MPI operations and strategy may be performed in three or four algorithmic steps, although it will be appreciated that the number of algorithmic steps will vary depending on implementation.

An exemplifying process will now be described. FIG. 13 shows a reduce-scatter strategy, wherein where Λ=6 and J=x=3. In this figure, the four columns represent steps 1-4 of the algorithm. At each algorithmic step, parallel logical graphs, called subgroups, are created between unique subset of devices, represented in FIG. 13 as a line. The left side of FIG. 13 represents the chord diagram of the example network for each step, with nodes grouped in communication groups, rack and device IDs. The right-hand side of the figure represents the connectivity matrix for each node at each step. The number representation of each node for the connectivity matrix is shown as the number inside each vertex of the chord diagram. While the graph is sparse, the network resources are maximised as each node uses x−1 transceivers for the first 3 steps and x for the last. In FIG. 13, an example of 3 subgroups is shown with black lines and the others are greyed out in the background. The devices in each subgroup will perform a partial collective operation, depending on the MPI operation.

In the first step of the reduce-scatter operation (Step 1), for each node, the overall message is divided in three portions and sent to different destinations in the subgroup. Then the information received is summed (reduced) in each node. The information portion (see table 3) that needs to be sent/received to/by each node is determined by the information map, and the transformation operations (e.g. summation) are dictated by the MPI operation. Each node now contains the sum of a unique ⅓ of information of the message in each subgroup.

The location of the information portion in every node after each communication step is tracked (see table 3). For the following steps, the subgroups are selected such that they include only nodes with same information portion combinations. In the second step (Step 2), the message is further partitioned in 3 parts ( 1/9 of the original message), transmitted to the correct node in each subgroup and processed. In the same way, the third step (Step 3) is performed, such that each device contains the sum of a unique 1/27 of the original information (global reduce-scatter). In the fourth step (Step 4), the information is exchanged between pair of nodes to complete information update across all 54 devices. This final step may have vary depending on the formulation chosen for subgroup selection.

A similar process, performed backwards (Step 4 to 1), is valid for all-gather, where unique portions of information are shared and gathered (concatenated) at each algorithmic step in every subgroup. In this way, starting with having 1/54 of the overall message, each node will contain a full 1/27, 1/9, ⅓ and whole information after Step 4, Step 3, Step 2 and Step 1 respectively.

### MPI Procedure

In some examples, the present example network architecture or aspects thereof may be combined with the present techniques relating to MPI operations, and will therefore provide a particularly performant solution to performing HPC operations. However, it will also be appreciated that the MPI operations discussed further below may be applied in any electrically packet switched or OCS network, or any port-level all-to-all network without oversubscription, and the benefits of the techniques discussed herein would still be realised.

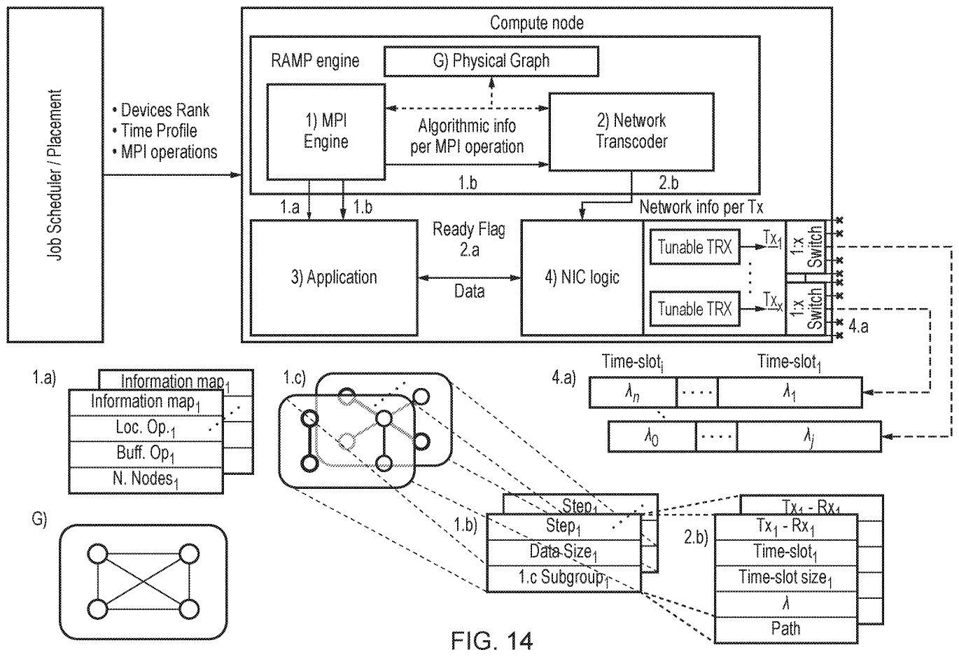

With reference to FIG. 14, an example node architecture and process of performing an MPI collective operation will now be discussed. It will be appreciated that each node in the network may perform the process simultaneously.

A distributed task/job is placed by a network job scheduler, and after this, information about the ranks of the nodes/coordinates of the nodes and the MPI operation to be performed are shared to all nodes involved. In particular, a node may receive MPI collective operation information identifying the MPI collective operation that is to be performed on data. The job scheduler may also provide time profile information to the node. In some examples, the ranks of the nodes are contained within a graph of the network, which is received by the node. This received information may be processed by an engine, as labelled in FIG. 14 as RAMP engine for example. The engine, or RAMP engine, comprises two components: an MPI engine 1 and a Network Transcoder 2 (discussed herein below).

The MPI Engine 1 uses the physical topology of the network (i.e. the graph of the network) and the MPI operation to generate instructions required by the Application 3 (processor of the node) and the Network Transcoder 2 to complete the collective operation. The MPI Engine 1 and Network Transcoder 2 handle scheduling and communication, while processing is handled by the application 3.

As indicated by FIG. 14, the MPI Engine 1 uses the physical graph G and the MPI operation information to calculate the number of algorithmic steps required to perform the MPI operation. This may be performed based on a look-up. In some examples, the MPI Engine 1 compares the MPI operation identified by the MPI operation information to a plurality of MPI operations stored in memory and their associated number of algorithmic steps. Based on this comparison, the number of algorithmic steps required for the MPI operation may be determined.

The MPI Engine 1 may then generate for each algorithmic step of the determined number of algorithmic steps, information 1.a and information 1.b. Information 1.a comprises the information required by the Application 3 to process and retrieve the data/message correctly for every step. The Application 3 is a processing module of the compute node. In some examples, information 1.a comprises only the information required by the Application 3. As shown in FIG. 14, information 1.a comprises, for each algorithmic step, an information map, local operation, buffer operation, and number of nodes. These will be discussed in greater detail below.

Information 1.b comprises the algorithmic information required by the Network Transcoder 2 to turn the information into information suitable for a Network Interface Card (NIC) 4. In particular, information 1.b comprises, for every algorithmic step, the data-size and the subgroup 1.c. The subgroup 1.c represents the logical graph (derived from the graph of the network G) of nodes performing a partial MPI operation at each algorithmic step. In other words, for every algorithmic step, the MPI Engine 1 determines a subset or subgroup of the nodes of the network that the node running the MPI Engine 1 should communicate with to complete the MPI operation. As shown in FIG. 14, the physical graph G is a graph of the node connections in the network, whereas 1.c indicates a subgrouping or subset of nodes of the physical graph G. As can be seen under 1.c, the current node executing the MPI Engine 1 is the lighter coloured node, and its subgroup is the node immediately below and connected to it.

The Network Transcoder 2 receives the information of 1.b from the MPI Engine 1 and the physical graph G and translates (trans-codes) it into instructions for the Network Interface Card 4. For each algorithmic step, the Network Transcoder 2 generates instruction 2.b for each individual transceiver (of FIG. 1 or 10 for example) to select time-slot size and number, transmitting/receiving wavelength and path. After processing these instructions, the Network Transcoder 2 sends ‘Ready’ flag/signal 2.a to the Application 3, signalling that the NIC 4 is ready for transmission. The Application 3 retrieves and transforms the data using 1.a such that it could be correctly handled and transmitted by the NIC 4 to perform the MPI operation. The Application 3 shares the processed data to the NIC 4, which using information 2.b, transforms it into signal 4.a on the physical system. The NIC 4 tunes the transceiver at the instructed wavelength and selects the correct SOA path (to turn on) for the given time-slot size.

The quantities of information 1.a and 1.b based on tables 1-4 described above. As above, the quantities referenced in the tables are defined as follows: the network comprises x communication groups; each communication group comprises J racks, wherein J≤x; each rack comprises Λ nodes; each node has a device number in a rack, λ, defined by 0≤λ≤Λ−1; each rack has a rack number, j, defined by 0≤j≤J−1; and the plurality of nodes in each rack are divided into device groups comprising x nodes, where each node has a unique device group number from 1 to x. It will be appreciated that the exact numbering scheme may vary, in that numbering may start from 1 rather than 0 for example.

### Information Map

The information map comprises the set of formulae describing the portion of information that should be sent-received and processed by each node at each algorithmic step. The formulae describing the information map at each algorithmic step for data transfer related strategies are described in table 3. The combination of values generated by the table across each algorithmic step represents the node rank. This also represents either the portion of the original message or the collected information available at the node after the last operation depending on the selected operation. The decimal representation of the information value at all algorithmic steps represents the rank of each node in the collective.

In some examples, the message is a vector or matrix of a defined length. Not all information of the message is needed by every node in each algorithmic step. For example, if the number of nodes communicating during an algorithmic step is N, the message will be split into N smaller portions. The information portion of the message that the node need to receive in terms of the index of these N smaller portions is found using the formulae listed in table 3. Thus, in an example where the information portion is 2, the node will need to receive the third smaller portion, (counting from 0 for example) out of N of the message.

### Local Operation

The local operation (Loc_op(DATA)) is the transformation performed on the received data after a communication step. The local operation is specific to the MPI operation being performed, as shown in table 2. The information map for the current step (info) is used to place in the correct order information coming from the NIC. There are four operations:

Reduce: associative operation, usually sum, between vectors received from different sources.

Reshape: used only in the all-to-all operation. Transpose the information (considered as a 3D array) in the source, rank dimension and flatten it into a one dimensional vector. This operation puts the information to be transmitted into contiguous portion of memory in the correct rank order.

Logical-AND between Booleans representing the presence of correct message. Only used for barrier operation.

Identity: no transformation is performed.

### Buffer Operation

The buffer operation (Buff_op) corresponds to transformation performed on the message before transmission that is generated by the MPI Engine and defined by the MPI Operation. The buffer operation is specific to the MPI operation being performed, as shown in table 2. It takes three arguments: the message that needs to be processed (DATA), the number of nodes in the current subgroup (nodes) and the information map for the current step (info). Info is used to sort the message in such a way that the correct portion of information is given to the correct transceiver.

As shown in table 2, there are three types of operations:

Reshape: the information vector is reshaped such that is divided into nodes addressable contiguous segments of same size.

Copy: the buffer size is increased by a factor of nodes and reshaped as described above. The original information will be in the segment of the array corresponding to the local rank of the node in the subgroup.

Identity: no transformation is performed.

### Number of Nodes

The number of nodes in each subgroup for each algorithmic step may be determined based on table 1. In other words, the number of nodes in each subgroup refers to the number of other nodes the current node will send data to and receive data from in each algorithmic step.

### Communication Subgroup Map

The subgroup (or subset) describes the set of nodes (logical graph) that each node needs to share information (communicate) with at any algorithmic step. Summary and formulae describing how each node is mapped to any subgroup at any communication step is shown in table 1. For this mapping, the nodes in a rack are further divided into groups of x devices called device groups, where each node has a unique device group number from 1 to x. Indeed, as discussed above, each node of the plurality of interconnected nodes has a unique node number, device number within a rack, rack number within a communication group, and communication group number.

The communication subgroups at each algorithmic step correspond to communication performed between unique set of devices in different system dimensions. These steps comprise:
Step 1: Nodes with the same node number, rack and different communication groups;
Step 2: Nodes with sequential node number in the same device group, rack and different communication group;
Step 3: Nodes with same node number, different rack and communication group;
Step 4: Nodes with same device group number, different device groups, racks and communication groups or nodes in sequential device groups with same device group number rack and different communication groups.

Depending on the selection of the formulation for subgroup in Step 4, two different operations may be used. When the first formulation is selected, the algorithms considered for the last step use strategies with one-to-one communication (such as ring, recursive halving/doubling and Bruck's), which might incur additional steps if the number of nodes is greater than 2 (value at maximum scale).

The subgroup selection defines the logical circuit which each node is part of for each algorithmic step, i.e. the group of nodes that will communicate. The number of nodes per subgroup, as shown in table 1, selects which of the four steps is active (#NS>1). From the subgroup information each node is able to know all sources and destinations active at any algorithmic step as described in table 1.

Using the information provided in table 1, the members of each subgroup can be found from each algorithmic step by each node. The formulae to find the coordinates (cluster number, group number in cluster, node number in group) of the other members of the same subgroup as the current node for each algorithmic step is shown in table 4.

### MPI Operation Algorithm

The combination of Buff_op and Loc_op is defined by the MPI operation (table 2), which will be performed on the message by the application. The pseudo-code for a single MPI operation running on an individual node is shown below in Alg.1. In Alg.1 starting with the local message, each node requests information to the MPI Engine given the current and active nodes' rank and the MPI operation (line 2). For each of the steps dictated by the MPI Engine, the DATA is first transformed by the Buff op (line 6) and after receiving confirmation from the Transcoder that the NIC is ready (line 7) pushes/receives data to/from the NIC which will be transformed by local operation (Loc_op, line 9) and will be used as the data for the next step.

The selection of Buff_op, Loc_op for each MPI operation is shown in table 2. The message sizes for each step and operation in table 2 are derived by the combination of Buff_op and Loc_op following Alg.1.

Algoritlun 1 Collective operation routine for single node

```
  1: DATA ← msg
  2:  steps, Loc_op, Buff_op_Info, map, n_nodes  ←
      MPI_Engine(my rank, devices rank, MPI Op)
  3: for step = 1 to steps do
  4: modes ← n_nodes[step]
  5: info ← Info_map[step]
  6: DATA ← ( Buff_op (DATA, nodes, info)
  7: WAIT ← Network_Transcoderready signal
  8: DATA ← NIC(DATA)
  9: DATA ← Loc_op(DATA, info)
10: end for
```

Reduce and All-Reduce operations have not been included in table 2. These are implemented by following an approach similar to the known Rabenseifner's algorithm, where the reduce and all-reduce operations are considered as a reduce scatter followed by a gather and all-gather operation respectively.

For the broadcast operation in table 2, the optical property of the system is used. Using SOA gating, one device may multi-cast data at full-node capacity to x² or x³ nodes depending on the selected system configuration. Given this property, a pipelined tree broadcast is created, where a root node can talk up to x² nodes, λ−1 of which will transmit to an additional x² devices each using different wavelengths. This creates a logical tree with diameter 3. The number of stages k for the pipeline considered is:

$$k = \sqrt{\frac{m \cdot ( s - 2 )}{α} β} , \qquad ( 1 )$$

where s is the diameter of the tree generated to perform the broadcast, a is communication setup latency (propagation and node/software dependent latencies) and β is the inverse of the total node capacity. The total number of steps needed to perform the operation is k+s−2 and the message transmitted per stage is message/k.

In this way, each node that is performing the collective operation may receive a graph of the network and MPI collective operation information that identifies an MPI collective operation to perform on data, and determine a number of algorithmic steps required to perform that MPI collective operation. For each step, the node determines a subset of the nodes for the node to communicate with, a portion of the data for the node to send, a process to perform on the portion of data before sending a message comprising the portion of data to the other nodes of the subset, and a size of the message comprising the portion of the data for the node to send to the nodes of the subset of nodes. The MPI collective operation is then initiated based on the determined portion of data, the determined process, the determined size of the message, and the determined subset of nodes.

### Network Transcoder

The Network Transcoder 2 uses the information from the MPI Engine 1 and collective operation and translates them to instructions for the NIC 4 to establish an optical circuit by just configuring the transceiver (wavelength) and the 1:x switches (path) of that node (see FIG. 14).

1) Wavelength mapping: Wavelength selection in OCS networks is fundamental to correctly route the information and avoid contention. Together with the subgroup selection, colour/wavelength is also assigned for each node to communicate appropriate information at each algorithmic step. The wavelength mapping varies for the various subnets and it uses a look-up table. Using subnet with only star coupler the mapping is dictated by the node receiving wavelength whereas with the AWGR it is forced by source/destination pair.

2) Subnet/Path/transceiver selection: For any source-destination pair, there are bx possible paths and subnets that allow communication. Between the parallel subgroups in the first three algorithmic steps, there might be up to bx communications using the same wavelength sharing the same set of subnets. To avoid contention, a wavelength must be used only once in the same subnet.

To minimise control complexity, the transceivers used by any node to perform collective operation are pre-determined. The transceiver groups chosen between any source destination pair are:

$$Trx ( d ( {g}_{src} , {j}_{src} , {λ}_{src} ) , d ( {g}_{dst} , {j}_{dst} , {λ}_{dst} ) ) = ( {g}_{src} + {g}_{dst} + {j}_{src} ) mod x , \qquad ( 2 )$$

where g_{src}−g_{dst}, j_{src}−j_{dst} and λ_{src}−λ_{dst} are the source and destination communication group, racks and node numbers respectively. The transceiver selection forces the subnet selection as each subnet is defined by the combination of g_{src}, g_{dst}, Tᵣₓ.

In practice, whenever the amount of devices per subgroup is smaller than the amount of communication groups, multiple transceiver groups might be used to communicate between the same source-destination pair. The additional number of transceiver groups that can be used for each communication in a collective operation is:

$$\# {TRX}_{additional} = ⌊ \frac{x - ⌊ x - d ⌋ ( d - 1 )}{d - 1} ⌋ , \qquad ( 3 )$$

where d is the number of devices in the active subgroup. If #TRX_{additional} is different than 0, then the additional transceiver groups are used for communication. The transceiver groups used for any communication pair is:

$$TRX ( {d}_{src} , {d}_{dst} ) = ⌈ Trx ( {d}_{src} , {d}_{dst} ) + \{ 0 , 1 , … , \# {TRX}_{additional} - 1 \} ⌉ mod x \cdot d , \qquad ( 4 )$$

where Trx(d_{src}, d_{dst}) is the original transceiver group described in Eq. 2.

From Eq. 4 the effective I/O unidirectional bandwidth of a node can be defined as:

$${B}_{IO Eff} = B \cdot b \cdot ( 1 + \# {TRX}_{additional} ) ( d - 1 ) . \qquad ( 5 )$$

For the fourth step, the transceiver selection may vary depending on the sub-groups formula selected (table 2). For the first formula, the number of transceiver groups used per communication is x as there would not be any contention for a single job. Selecting the second formula, the transceiver mapping follows Eq. 4 where the maximum number of transceiver groups that can be used per communication is └x/J┘, due to contention between racks.

3) Time-slot mapping: The time-slot map is given by the data-transmitted per step (table 4) and the effective bandwidth per transceiver (Eq. 5), and gives deterministic communication latency. It is possible to further increase the number of parallel jobs selecting different subnets (e.g. AWGR based subnets allow supports different device numbers sets, same reason as for the communication groups set).

### Example MPI Collective Operations and Strategy

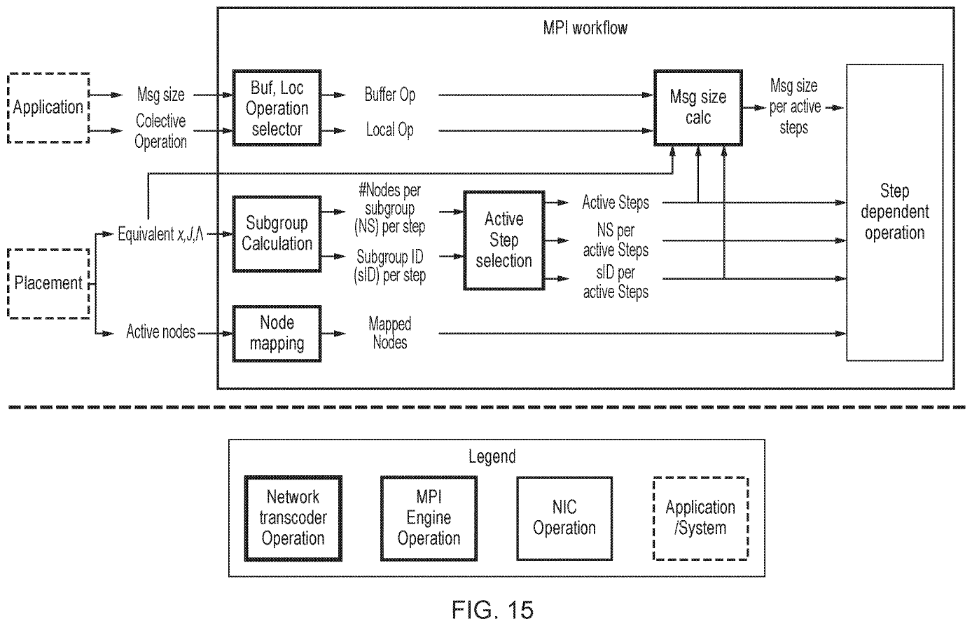

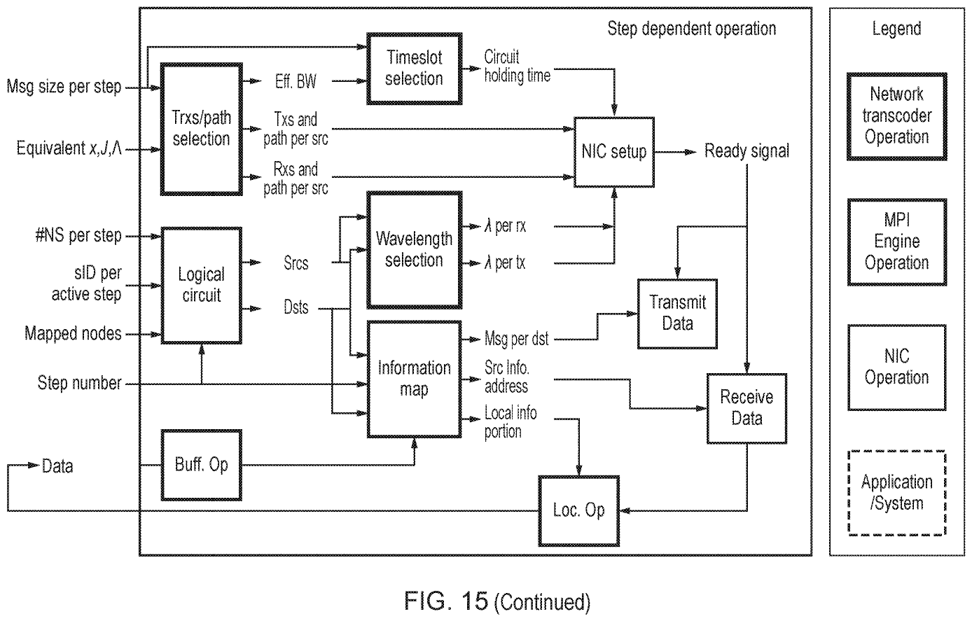

In some examples, to perform a complete MPI operation, each node performs the following operations as described in FIG. 15. Each node first receives from the job allocator/scheduler the collective operation, the message size, the active nodes for the collective and network coordinates in terms of communication groups (x), racks (J) and node numbers (Λ) (or cluster number, group number in cluster, and node number in group). Using this information, each node calculates its subgroup ID and the number of nodes in each subgroup for each algorithmic step, based on table 1 (stored in memory of each node), and as described above in section ‘Communication subgroup map’. While these are calculated, also the active steps (the steps of collective operation that have to be run) are selected, as they will have a number of nodes>1. In other words, the combination of local operation and buffer operation is determined based on table 2, and as described in section ‘Buffer operation’, Local operation’, and ‘MPI operation algorithm’. Then for each active step, the logical circuits or subgroups (nodes with the same subgroup ID) are found based on table 1 and 4, and as discussed in section ‘Communication subgroup map’.

Once the logical circuit/subgroup of nodes, i.e. the nodes that are to communicate at that algorithmic step, have been identified the information portion that needs to be sent to each of them is calculated based on table 3, and as discussed in section ‘Information map’ and stored in a lookup table. From the information portion and the buffer operation, the message size per source-destination pair is calculated. Using the graph of the network and logical circuit information (subgroups) the transceivers for each source-destination pair are selected, which determines the effective bandwidth of the node pair communication. From the message size and effective bandwidth, the number of time-slots per communication is determined and the wavelength and path per active transceiver are selected. The received data is processed by the local operation and considered as the message for the next active step.

All the information is deterministic and pre-computed at application setup, such that it can be used as a lookup table at runtime following the principles described in section ‘MPI operation algorithm’.

Thus, there have been described various techniques for improving network performance for HPC applications. In particular, techniques for initialising and performing MPI operations have been described, and network architectures in which the techniques may be performed have been described. It will be appreciated that techniques relating to MPI initialisation and performance and the network architectures may be implemented separately.

The methods discussed above may be performed under control of a computer program executing on a computing node/device, for example any of the nodes described in the figures herein. The computing node may comprise one or more processors, memory, and communication circuitry. Hence, a computer program may comprise instructions for controlling a computing device/node to perform any of the methods discussed above. The program can be comprised in a computer-readable medium. A computer readable medium may include non-transitory type medium such as physical storage media, for example storage discs and solid state devices. A computer readable medium may additionally or alternatively include transient media such as carrier signals and transmission media, which may for example occur to convey instructions between a number of separate computer systems, and/or between components within a single computer system.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the disclosure scope defined by the claims or limitations on equivalents to the claims, and that other embodiments may be utilised and modifications may be made without departing from the scope of the invention as defined by the claims.

1. A method for performing a message passing interface (MPI) collective operation in a network, wherein the network comprises a plurality of interconnected nodes, the method comprising:
receiving, at a node of the plurality of interconnected nodes, MPI collective operation information identifying the MPI collective operation to be performed, and a graph of the network;
determining a number of algorithmic steps of the MPI collective operation based on the MPI collective operation and the graph of the network;
determining an initialisation process for the algorithmic steps;
determining a finalisation process for the algorithmic steps;
determining, for each of the algorithmic steps:
a subset of nodes of the plurality of interconnected nodes for the node to communicate with; and
one or more portions of data for the node to send to and receive from the nodes within the subset of nodes; and
initialising the MPI collective operation based on the determined subset, initialisation process and finalisation process, and the one or more portions of data.

2. The method of claim 1, wherein each node of the plurality of interconnected nodes is configured to perform the method.

3. The method of claim 1, wherein each subset of nodes of each of the algorithmic steps is unique.

4. The method of claim 1, wherein determining the number of algorithmic steps is based on retrieving stored information associated with the MPI operation.

5. The method of claim 1, wherein the network is a circuit switched network, wherein optionally the network is an optical circuit switched network.

6. The method of claim 1, wherein:
the network comprises one or more clusters, each cluster comprising one or more groups, each group comprising one or more nodes;
each node of the plurality of interconnected nodes has a node number within a group,
group number within a cluster, and cluster number; and
the graph comprises information indicating the node number, group number, and cluster number of each node.

7. The method of claim 6, wherein for a first of the algorithmic steps, the subset of nodes comprises nodes with the same node number, same group number, and different cluster number.

8. The method of claim 6, wherein the plurality of nodes in each group are divided into node sets comprising x nodes, where each node has a unique node set number from 1 to x, and where x is the number of clusters.

9. The method of claim 8, wherein for a second of the algorithmic steps, the subset of nodes comprises nodes with sequential node number in the same node set, the same group number, and different cluster number.

10. The method of claim 8, wherein for a third of the algorithmic steps, the subset of nodes comprises nodes with the same node number, different group number, and different cluster number.

11. The method of claim 8, wherein for a fourth of the algorithmic steps:
the subset of nodes comprises nodes with the same node number in a node set, different node sets, same group numbers, and different clusters; or
the subset of nodes comprises nodes in sequential node sets with the same node number in a node set, the same group number and different cluster number.

12. The method of claim 1, wherein
determining, for each of the algorithmic steps, the subset of nodes comprises:
determining an identifier of the subset of nodes;
determining a number of nodes in the subset of nodes; and
determining other nodes within the subset of nodes for the node to communicate with.

13. The method of claim 12, wherein:
the network comprises x clusters;
each cluster comprises J groups, wherein J≤x;
each group comprises Λ nodes;
each cluster has a cluster number, g, defined by 0≤g≤x−1;
each node has a node number in a group, λ, defined by 0≤λ≤Λ−1;
each group has a group number, j, defined by 0≤j≤J−1; and
the plurality of nodes in each group are divided into node sets comprising x nodes, where each node has a unique node number in the node set from 1 to x.

14. The method of claim 13, wherein:
for a first of the algorithmic steps, the total number of subsets of nodes=ΛJ, each subset having an identifier, i;
the total number of nodes per subset is x; and
for the first of the algorithmic steps, the identifier of the subset is determined based on the following formula:
$$i = λ + Λ \cdot j .$$

15. The method of claim 13, wherein:
for a second of the algorithmic steps, the total number of subsets of nodes=ΛJ;
the total number of nodes per subset is x; and
for the second of the algorithmic steps, the identifier of the subset is determined based on the following formula:
$$i = ( λ - g ) mod x + Λ j + ⌊ λ / x ⌋ x .$$

16. The method of claim 13, wherein:
for the third algorithmic step, the total number of subsets of nodes=Λx;
the total number of nodes per subset is J; and
for the third algorithmic step, the identifier of the subset is determined based on the following formula:
$$i = ( λ + Λ ( j - g ) ) mod ( Λ j ) .$$

17. The method of claim 13, wherein:
for the fourth algorithmic step, the total number of subsets of nodes=Jx²;
the total number of nodes per subset is Λ/x; and
for the fourth algorithmic step, the identifier of the subset is determined based on the following formula:
$$a )$$
$$i = ( λ - ⌊ λ / x ⌋ x ) mod x + {x}^{2} j + ( ( g - j ⌊ λ / x ⌋ ) mod x ) x ;$$
$$or$$
$$b )$$
$$i = {x}^{2} j + x [ ( g - ⌊ λ / x ⌋ x ) mod x ] + λ mod x .$$

18. The method of claim 13, wherein determining the other nodes within the subset of nodes further comprises determining the node number, group number, and cluster of the other nodes based on the following:
```
for a first of the algorithmic steps:
      node number = λ;
      group number = j; and
      cluster = (g + γ) mod x,
      wherein ≤ γ ≤ x − 1;
for a second of the algorithmic steps:
      node number = (λ modx + γ)modx + x└λ/x┘;
      group number = j; and
      cluster = (g + λ) mod x,
      wherein 0 ≤ γ ≤ x − 1;
for a third of the algorithmic steps:
      node number = λ;
      group number = [(j + γ) mod J − j]mod J; and
      cluster = [(g − j) mod x + γ] mod x, wherein
      wherein 0 ≤ γ ≤ J − 1; and
for a fourth of the algorithmic steps:
      node number = λmodx + x × [(└λ/x┘ + 1)modΛ/x┘], or
                  λmodx + x x [(γ + └λ/x┘)mod└λ/x┘] − └λ/x┘]mod └Λ/x ┘;
      group number = j; and
      cluster = (g + j − └(└λ/x┘ + 1)/ └Λ/x┘┘ × (└λ/x┘ + 1) * j)modx, or
            [(g − └λ/x┘) modx + γ]modx,
      wherein 0 ≤ γ ≤ └Λ/x┘.
```

19. The method of claim 13, the method further comprising:
responsive to determining that the MPI operation is a reduce scatter operation, selecting as the initialisation process a reshape process and selecting as the finalisation process a reduce process;
responsive to determining that the MPI operation is an all-gather operation, selecting as the initialisation process a copy process and selecting as the finalisation process an identity process;
responsive to determining that the MPI operation is a barrier operation, selecting as the initialisation process an identity process and selecting as the finalisation process a logical AND process;
responsive to determining that the MPI operation is an all-to all operation, selecting as the initialisation process a reshape process and selecting as the finalisation process a reshape process;
responsive to determining that the MPI operation is a scatter operation, selecting as the initialisation process a reshape process and selecting as the finalisation process an identity process;
responsive to determining that the MPI operation is a gather operation, selecting as the initialisation process a copy process and selecting as the finalisation process an identity process;
responsive to determining that the MPI operation is a broadcast operation, selecting the processes associated with the scatter operation and the all-gather operation; and
responsive to determining that the MPI operation is an all-reduce operation, selecting the processes associated with the reduce-scatter operation and all-gather operation.

20. The method of claim 13, wherein:
for a first of the algorithmic steps, the one or more portions of data is determined based on the following: portion of data=(g−λ−j−└λ/x┘j) mod x;
for a second of the algorithmic steps, the portion of data is determined based on the following: portion of data=(g−j−└1/x┘j) mod x;
for a third of the algorithmic steps, the portion of data is determined based on the following: portion of data=j; and
for a fourth of the algorithmic steps, the portion of data is determined based on the following: portion of data=└1/x┘.

21. The method of claim 13, wherein a received message size is m, the method further comprising:
responsive to determining that the MPI operation is a reduce scatter operation:
for a first of the algorithmic steps selecting the size of a message as m/x, for a second of the algorithmic steps selecting the size of a message as m/x², for a third of the algorithmic steps selecting the size of a message as m/(Jx²), for a fourth of the algorithmic steps selecting the size of a message as m/(JΛx);
responsive to determining that the MPI operation is an all-gather operation:
for a first of the algorithmic steps selecting the size of a message as m·JΛx, for a second of the algorithmic steps selecting the size of a message as m·JΛ, for a third of the algorithmic steps selecting the size of a message as m·JΛ/x, for a fourth of the algorithmic steps selecting the size of a message as m·Λ/x;
responsive to determining that the MPI operation is a barrier operation:
for a first of the algorithmic steps selecting the size of a message as 0, for a second of the algorithmic steps selecting the size of a message as 0, for a third of the algorithmic steps selecting the size of a message as 0, for a fourth of the algorithmic steps selecting the size of a message as 0;
responsive to determining that the MPI operation is an all-to-all operation:
for a first of the algorithmic steps selecting the size of a message as m/x, for a second of the algorithmic steps selecting the size of a message as m/x, for a third of the algorithmic steps selecting the size of a message as m/J, for a fourth of the algorithmic steps selecting the size of a message as m·x/Λ;
responsive to determining that the MPI operation is a scatter operation:
for a first of the algorithmic steps selecting the size of a message as m/x, for a second of the algorithmic steps selecting the size of a message as m/x², for a third of the algorithmic steps selecting the size of a message as m/(Jx²), for a fourth of the algorithmic steps selecting the size of a message as m/(JΛx);
responsive to determining that the MPI operation is a gather operation:
for a first of the algorithmic steps selecting the size of a message as m·JΛx, for a second of the algorithmic steps selecting the size of a message as m·JΛ, for a third of the algorithmic steps selecting the size of a message as m·JΛ/x, for a fourth of the algorithmic steps selecting the size of a message as m·(Λ/x); and
responsive to determining that the MPI operation is a broadcast operation:
determining the size of a message for each step based on a message size determined from a scatter and all-gather operation.

22. The method of claim 13, further comprising, for each of the algorithmic steps, storing in memory the determined subset of nodes, and one or more portions of data, wherein the method further comprises:
after initialising the MPI operation, receiving a message associated with the MPI collective operation;
performing a first of the algorithmic steps by:
processing the message with the determined initialisation process;
sending the determined one or more portions of the processed message to the respective node or nodes of the subset;
receiving a message from a node within the subset; and
processing the received message with the finalisation process, wherein the processed received message becomes the message for the subsequent algorithmic step, and wherein performing of the algorithmic steps is repeated for all of the determined algorithmic steps using the determined respective information for each step.

23. The method of claim 22, wherein performing each of the algorithmic steps comprises providing a network transcoder of the node with the determined subset of nodes and the one or more data portions, the method further comprising, translating, by the network transcoder, the determined subset of nodes and the one or data portions into instructions for configuring one or more transceivers of the node.

24. A node for performing a message passing interface (MPI) collective operation on data in network, wherein the network comprises a plurality of interconnected nodes, the node comprising a processor configured to:
receive, at the node of the plurality of interconnected nodes, MPI collective operation information identifying the MPI collective operation to be performed, and a graph of the network;
determine a number of algorithmic steps of the MPI collective operation based on the MPI collective operation and the graph of the network;
determine an initialisation process for the algorithmic steps;
determine a finalisation process for the algorithmic steps;
determine, for each of the algorithmic steps:
a subset of nodes of the plurality of interconnected nodes for the node to communicate with; and
one or more portions of data for the node to send to and receive from the nodes within the subset of nodes; and
initialize the MPI collective operation based on the determined subset, initialisation process and finalisation process, and the one or more portions of data.

25. Computer-readable media comprising instructions which, when executed by a processor, cause the processor to;
receive, at a node of a plurality of interconnected nodes in a network, message passing interface (MPI) collective operation information identifying the MPI collective operation to be performed in the network, and a graph of the network, wherein;
determine a number of algorithmic steps of the MPI collective operation based on the MPI collective operation and the graph of the network;
determine an initialisation process for the algorithmic steps;
determine a finalisation process for the algorithmic steps;
determine, for each of the algorithmic steps:
a subset of nodes of the plurality of interconnected nodes for the node to communicate with; and
one or more portions of data for the node to send to and receive from the nodes within the subset of nodes; and
initialize the MPI collective operation based on the determined subset, initialisation process and finalisation process, and the one or more portions of data.
